(19) United States
(12) Patent Application Publication
(10) Pub. No.: US 2023/0136144 A1
(43) Pub. Date: May 4, 2023

(54) Smart Clamp with Base-side Blocking Valve

(71) Applicant: Rightline Equipment, Inc., Rainier, OR (US)

(72) Inventors: JIM D. HAMLIK, Vancouver, WA (US); JOEL D. HAMLIK, Vancouver, WA (US); HUNTER WICKERT, Vancouver, WA (US)

(21) Appl. No.: 17/910,330

(22) PCT Filed: Mar. 8, 2021
(86) PCT No.: PCT/US21/21420

§ 371 Date: Sep. 8, 2022

Related U.S. Application Data
(60) Provisional application No. 62/986,767, filed on Mar. 8, 2020.
(60) Provisional application No. 63/043,776, filed on Jun. 24, 2020.

(51) Int. Cl. B66F 9/24; B66F 9/18; B66F 9/22

(52) U.S. Cl. CPC B66F 9/24; B66F 9/183; B66F 9/22

(57) ABSTRACT

A smart clamp load handler configured for controlling movement of its clamp arms and force applied by its clamp arms by changing positions of one or more solenoid operated valves to control hydraulic fluid flow to and from clamp arm actuators, based on pressure measurements from one or more pressure sensors.

### CROSS-REFERENCE TO RELATED APPLICATIONS

This application is a National Stage of International Application No. PCT/US21/21420, filed 2021 Mar. 8, which claims the benefit of U.S. Provisional Application No. 62986767, filed 2020 Mar. 8, and U.S. Provisional Application No. 63043776, filed 2020 Jun. 24, all incorporated herein by reference.

### FIELD OF THE INVENTION

The present invention relates to cargo handling equipment. More particularly, the present invention relates to load clamps for use primarily with lift trucks.

### BACKGROUND

Material handling vehicles such as lift trucks are used to pick up and deliver loads between stations. A typical lift truck 10 has a mast 12, which supports a carriage 14 that can be raised along the mast 12 (see FIG. 1). The carriage 14 typically has one or more carriage bars 16 to which a fork frame 18 is mounted. The carriage bars 16 are coupled to the mast in a way that allows the lift truck 10 to move the carriage bars 16 up and down, but not laterally relative to the truck. The fork frame 18 carries a pair of forks 20. An operator of the lift truck 10 maneuvers the forks 20 beneath a load prior to lifting it.

Instead of forks 20, a lift truck 10 may have other kinds of attachments coupled to its mast 12. One type of attachment is a clamp load handler 32 (See FIG. 2). The clamp load handler 32 typically comprises a frame 40, one or more actuators 36 and two clamp arms 34. The actuators 36 are configured to move the clamp arms 34 toward or away from each other with actuator rods 38. The clamp arms 34 typically have a gripping material on the inside surfaces that contact the load. The gripping material, such as rubber or polyurethane, provides high friction contact surface for gripping the load and also provides a compressible and resilient contact surface to protect the load from superficial damage from the clamp arms 34. In use, the operator of the lift truck 10 approaches a load to be carried, such as a stack of cartons or a large appliance, such as a refrigerator. As the lift truck 10 approaches the load, the operator uses controls to open the gap between the clamp arms 34 wider than the load and may adjust the height of the clamp arms 34 so they will engage the load in a suitable location. The operator then maneuvers the lift truck 10 to straddle the load between the clamp arms 34. When the clamp arms 34 are positioned suitably around the load, the operator uses controls to bring the clamp arms 34 together, grasping the load. The operator then uses other controls to raise the load clamp assembly 22, raising the load off the floor, the load held between the clamp arms 34 by friction. The operator then drives the load to a desired location. The amount of force the clamp arms 34 apply must be “just right.” Too little force and the load may slip out of the clamp arms 34, which can be disastrous, particularly when the lift truck 10 is moving. Too much force can crush the load. With only manual control of the clamp arms 34, applying just the right amount of force is completely dependent on the lift truck operator. Even a skilled operator's ability to apply just the right amount of force is limited because they cannot feel the amount of force being applied and must rely on visual and audio indications of how much force is being applied.

### BRIEF DESCRIPTION OF THE DRAWINGS

The present invention will be described by way of representative embodiments, illustrated in the accompanying drawings in which like references denote similar elements, and in which:

FIG. 1 is an isometric view of a prior art lift truck, illustrating typical components of a lift truck 10 equipped with forks 20.

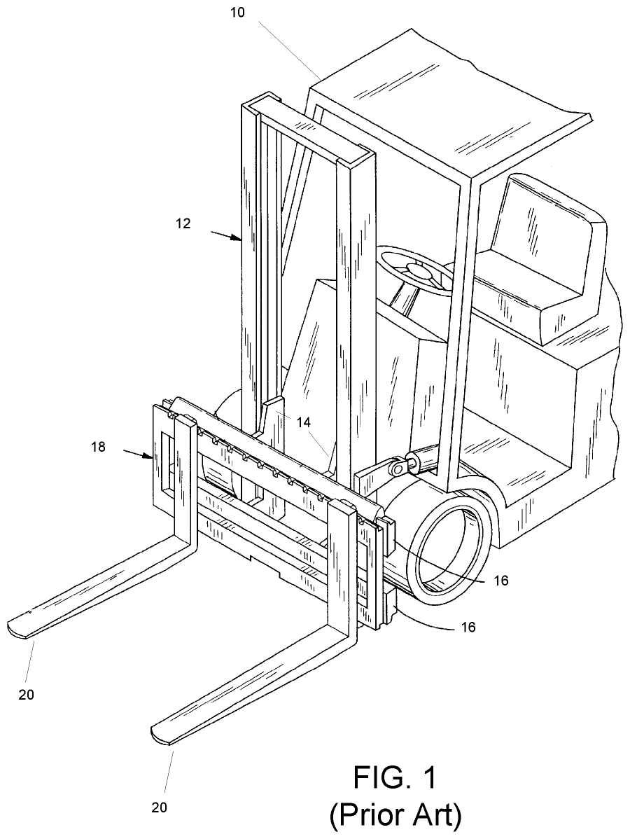

FIG.2 is an isometric view of a prior art lift truck 10, illustrating typical components of a lift truck 10 equipped with a load clamp assembly 22.

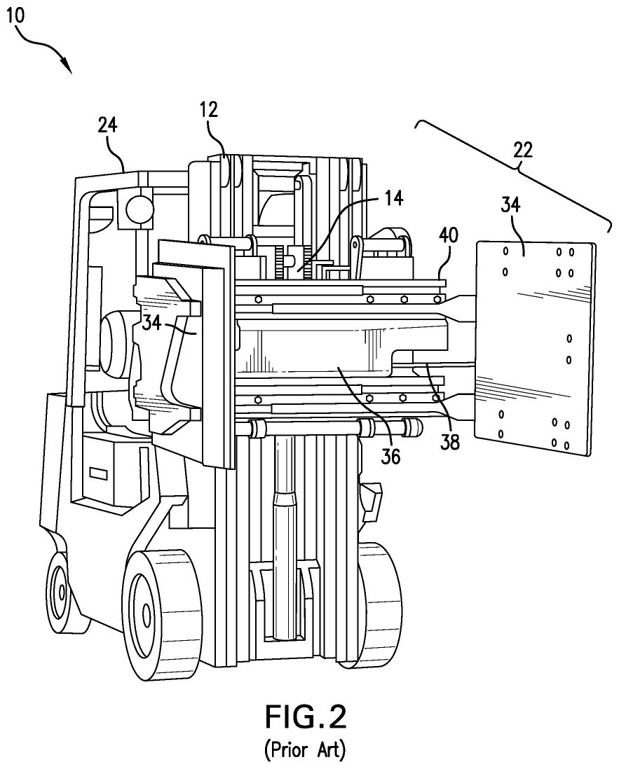

FIG. 3 shows a perspective view of the main structural components of a first representative embodiment smart clamp load handler 104 (hydraulic lines and electrical controls not shown).

FIG. 4A shows a schematic of a first representative embodiment smart clamp system 100 in a fully open phase of operation (before time 0 in FIG. 5).

FIG. 4B shows a schematic of a first representative embodiment smart clamp system in a closing phase of operation (time 0 to time 302 in FIG. 5).

FIG. 4C shows a schematic of a first representative embodiment smart clamp system 100 in an equalization phase of operation (time 302 to time 303 in FIG. 5).

FIG. 4D shows a schematic of a first representative embodiment smart clamp system 100 at the end of the equalization phase of operation (at time 303 in FIG. 5).

FIG. 4E shows a schematic of a first representative embodiment smart clamp system 100 in a force adjustment clamping phase of operation (time 303 to time 304 in FIG. 5).

FIG. 4F shows a schematic of a first representative embodiment smart clamp system 100 in a clamped phase of operation (time 304 to time 305 in FIG. 5).

FIG. 4G shows a schematic of a first representative embodiment smart clamp system 100 in an opening of operation in which the clamp arms release and move away from the load.

FIG. 5 shows a graph over time of the forces generated by the first representative embodiment smart clamp system 100 during clamping operations.

FIG. 6A shows a schematic of a second representative embodiment smart clamp system 400 in an equalization phase of operation (time 302 to time 403 in FIG. 6C).

FIG. 6B shows a schematic of a second representative embodiment smart clamp system 400 in a slow adjustment phase of operation (time 403 to time 404 in FIG. 6C).

FIG. 6C shows a graph over time of the forces generated by the second representative embodiment smart clamp system 400 during clamping operation.

FIG. 7 shows a schematic of a third representative embodiment smart clamp system 500 in a force adjustment phase of operation.

FIG. 8 shows a schematic of a fourth representative embodiment smart clamp system 600 in an equalization phase of operation.

FIG. 9A shows a schematic of the fifth representative embodiment smart clamp system 700 in a closing phase of operation (time 0 to time 302 in FIG. 9D).

FIG. 9B shows a schematic of a fifth representative embodiment smart clamp system 700 in an equalization phase of operation (time 302 to time 403 in FIG. 9D).

FIG. 9C shows a schematic of a fifth representative embodiment smart clamp system 700 in a slow adjustment phase of operation (time 403 to time 404 in FIG. 9D).

FIG. 9D shows a graph over time of the forces generated by the fifth representative embodiment smart clamp system 700 during clamping operations.

### DETAILED DESCRIPTION

Before beginning a detailed description of the subject invention, mention of the following is in order. When appropriate, like reference materials and characters are used to designate identical, corresponding, or similar components in different figures.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Use of directional terms such as “upper,” “lower,” “above,” “below”, “in front of,” “behind,” etc. are intended to describe the positions and/or orientations of various components of the invention relative to one another as shown in the various figures and are not intended to impose limitations on any position and/or orientation of any embodiment of the invention relative to any reference point external to the reference. Herein, “left” and “right” are from the perspective of an operator seated in a lift truck facing the carriage of the lift truck. Herein, “lateral” refers to directions to the left or the right and “longitudinal” refers to a direction perpendicular to the lateral direction and to a plane defined by the carriage.

Those skilled in the art will recognize that numerous modifications and changes may be made to the various embodiments without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the first embodiment is essential. Other embodiments are possible, their specific designs depending upon the particular application. As such, the scope of the invention should not be limited by the particular embodiments herein described but should be defined only by the appended claims and equivalents thereof.

### First Representative Embodiment—Structure

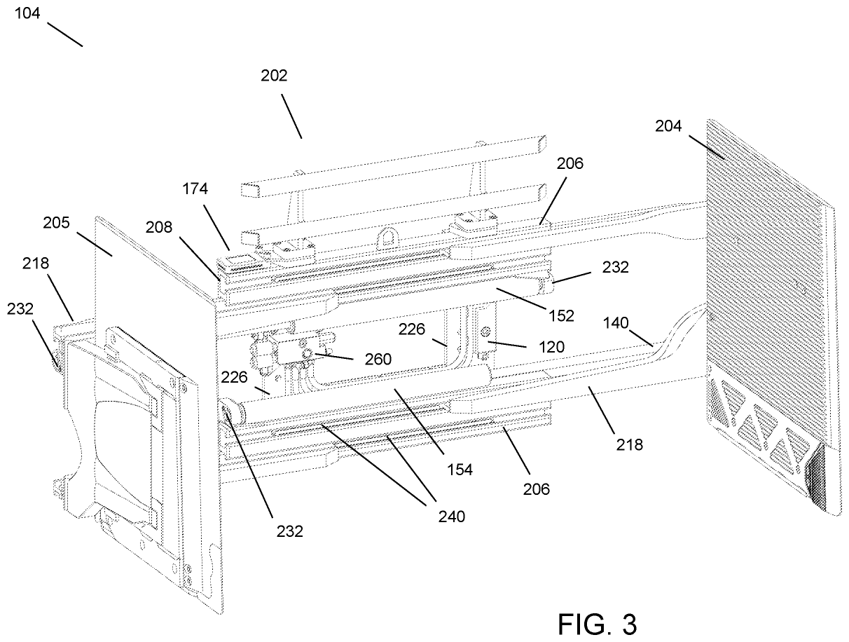

FIG. 3 shows a perspective view of the main structural components of a first representative embodiment smart clamp load handler 104. The smart clamp load handler 104 comprises a frame 202, a pair of clamp arms 204, 205 coupled to the frame 202 and a pair of clamp actuators 152, 154. A first clamp actuator 152 is coupled to a first clamp arm 204 and a second clamp actuator 154 coupled to a second clamp arm 205. The clamp actuators 152, 154 are configured to pull the clamp arms 204, 205 together or push them apart.

The frame 202 is configured to be coupled to a carriage 14 of a lift truck 10. The frame 202 comprises two frame vertical beams 226 with four guide channels 206 coupled thereto. Two guide channels 206 are positioned near a top of the frame 202 and two guide channels 206 are positioned near a bottom of the frame 202. In the first representative embodiment smart clamp load handler 104, the upper two guide channels 206 share a common channel wall and the lower two guide channels 206 are similar. However, in other embodiments, the guide channels 206 do not necessarily have common walls with adjacent guide channels 206, the frame 202 may have more or fewer guide channels 206 and the guide channels may be arranged differently.

Each of the guide channels 206 has a guide channel cavity 208. The guide channels 206 each have a guide channel slot 240 on the front, opening to the guide channel cavity 208. Each guide channel 206 has a channel bearing, positioned inside the guide channel cavity 208 and shaped to conform thereto, and with its own interior cavity that is similarly shaped, but slightly smaller. The channel bearing is detachably coupled to the guide channel 206. The channel bearings are made of suitable bearing material that provides low friction and is softer than the components it has sliding contact with in order to preferentially wear. Since the channel bearings are removable, they can be easily replaced when worn down.

Each clamp arm 204, 205 has two clamp sliding beams 218 coupled thereto. The two clamp sliding beams 218 are configured to slidingly fit into two of the guide channels 206 of the frame 202. More specifically, the clamp sliding beams 218 insert into the channel bearings of the guide channels 206 with a sliding fit. In the representative embodiment, the portion of each clamp sliding beam 218 inserted into the guide channel 206 has a “T” cross-section, with the top of the “T” held inside the guide channel 206 and the base of the “T” extending out of the guide channel slot 240. However, in other embodiments, the guide channel 206 and the clamp sliding beam 218 may have other suitable cross-sectional shapes.

Two actuator brackets 232 are coupled to the frame 202, one coupled to a bottom of a lower of the top two guide channels 206, and the other coupled to a top of an upper of the bottom two guide channels 206. The upper actuator bracket 232 is position on the left of the frame 202 and the lower actuator bracket 232 is located on the right of the frame 202, when viewed from the lift truck 10. Each of the clamp actuators 152, 154 is coupled to the frame 202 via one of the actuator brackets 232. Each clamp actuators 152, 154 has an actuator rod 140 that is coupled to an actuator bracket 232 on one of the clamp arms 204, 205.

Coupled to the frame 202 are a controller 120, a control console 174, and a hydraulic manifold 260. The controller 120 and control console 174 are described in detail elsewhere herein. The hydraulic manifold 260 has several valves, described in detail elsewhere herein.

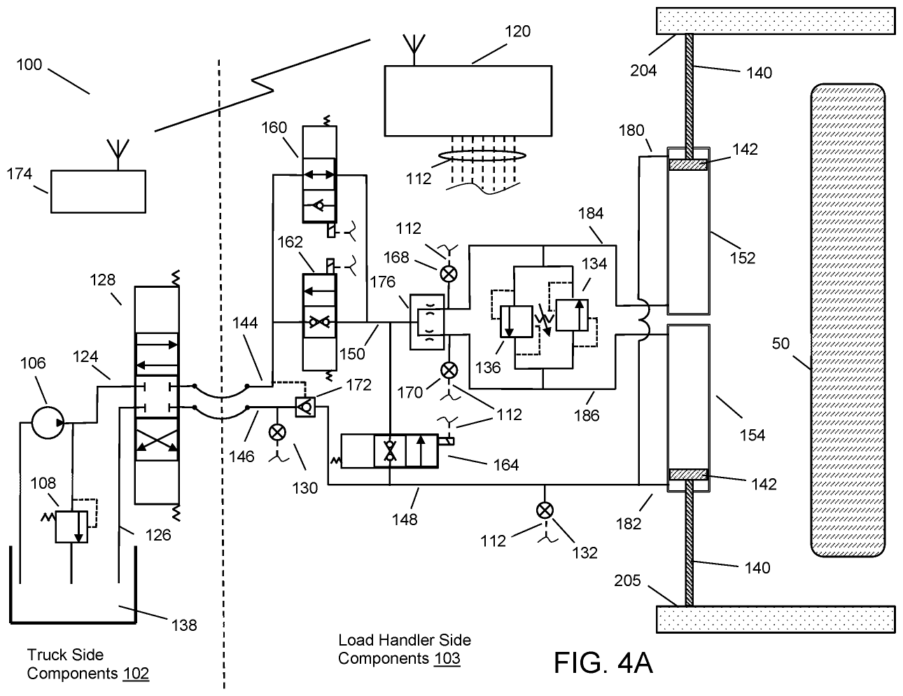

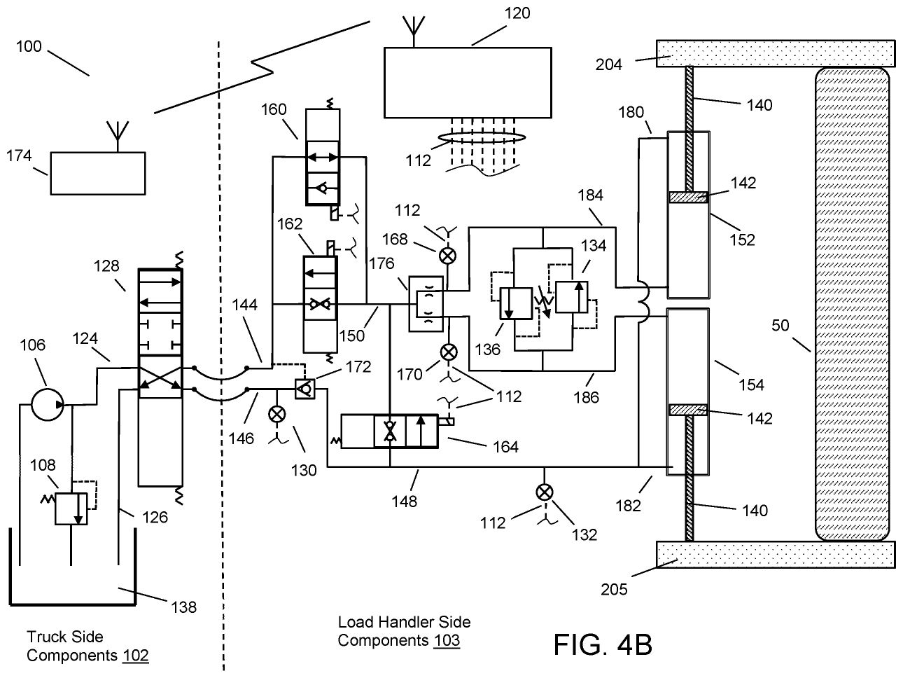

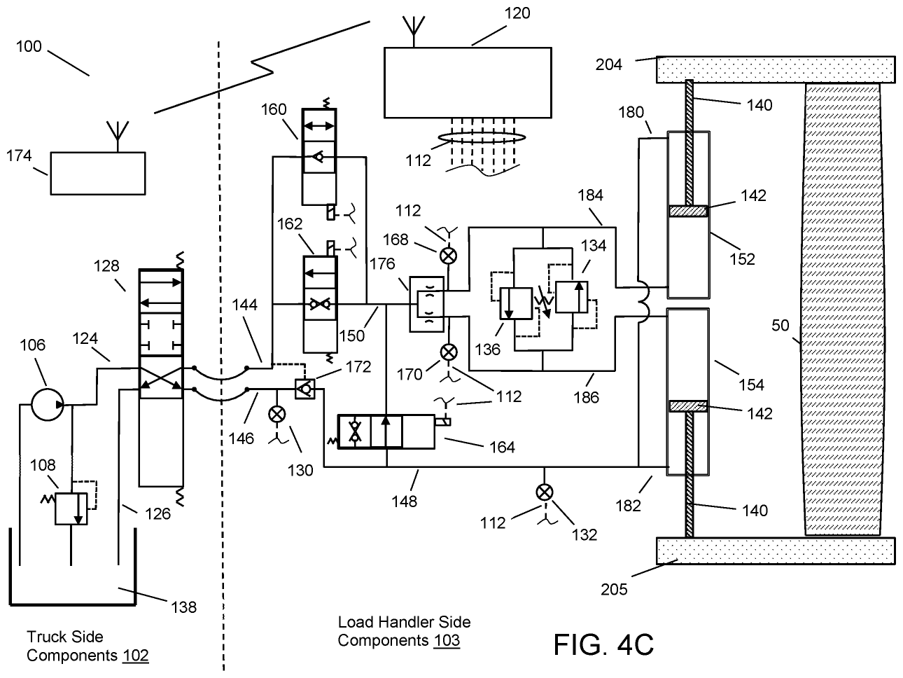

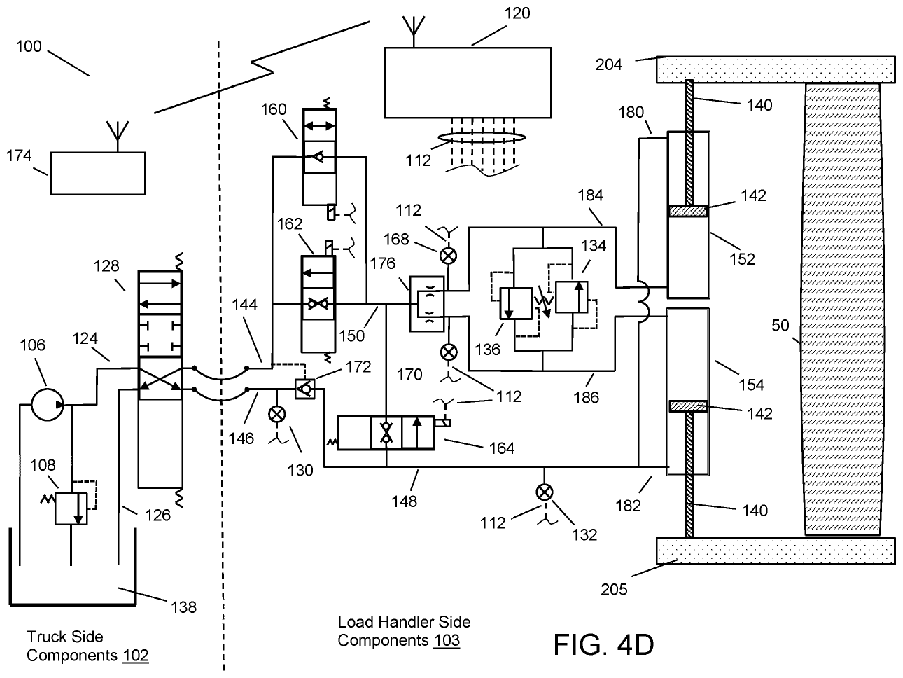

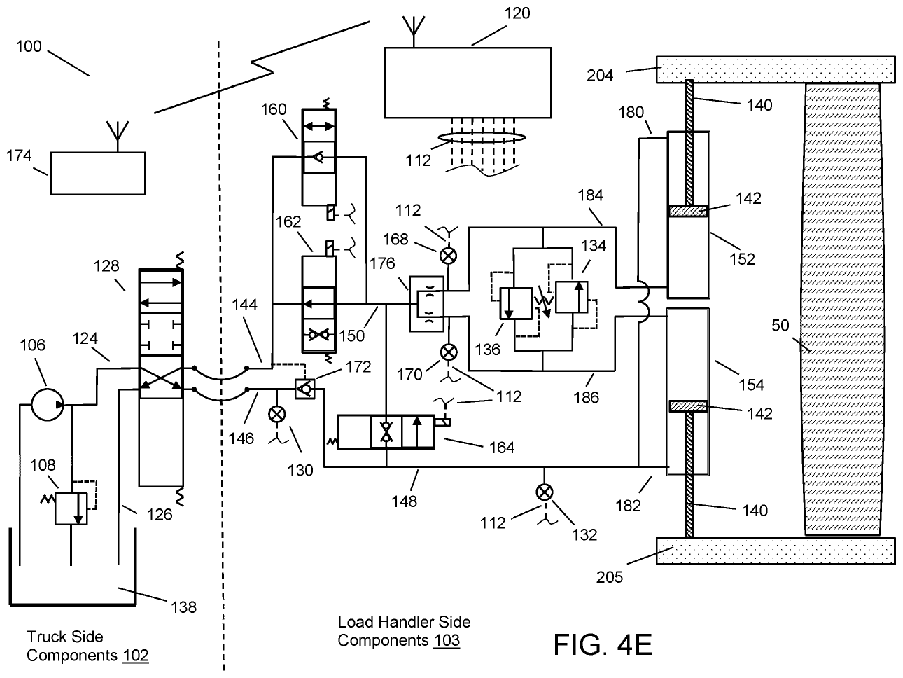

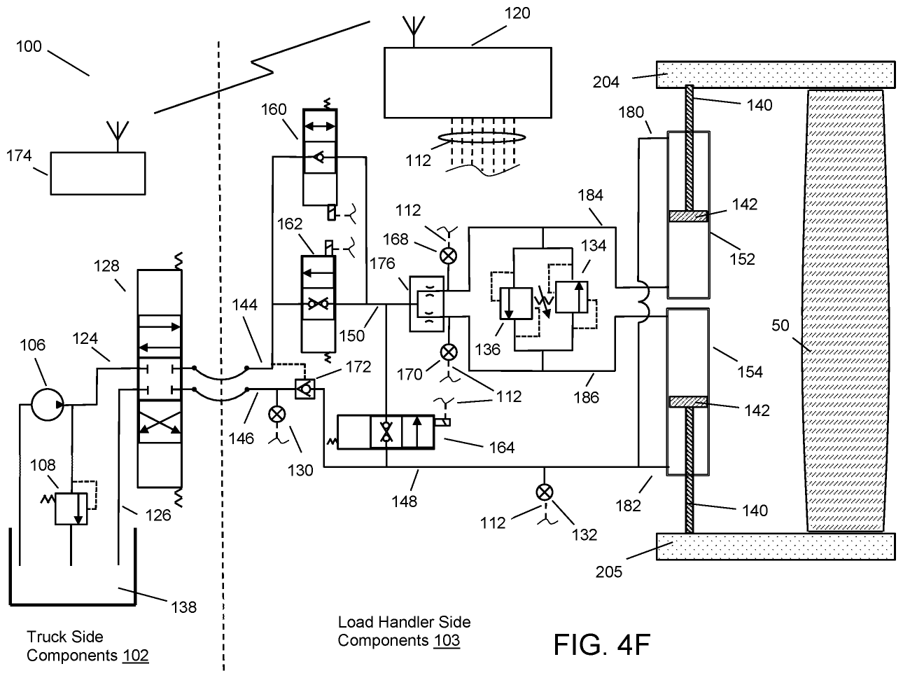

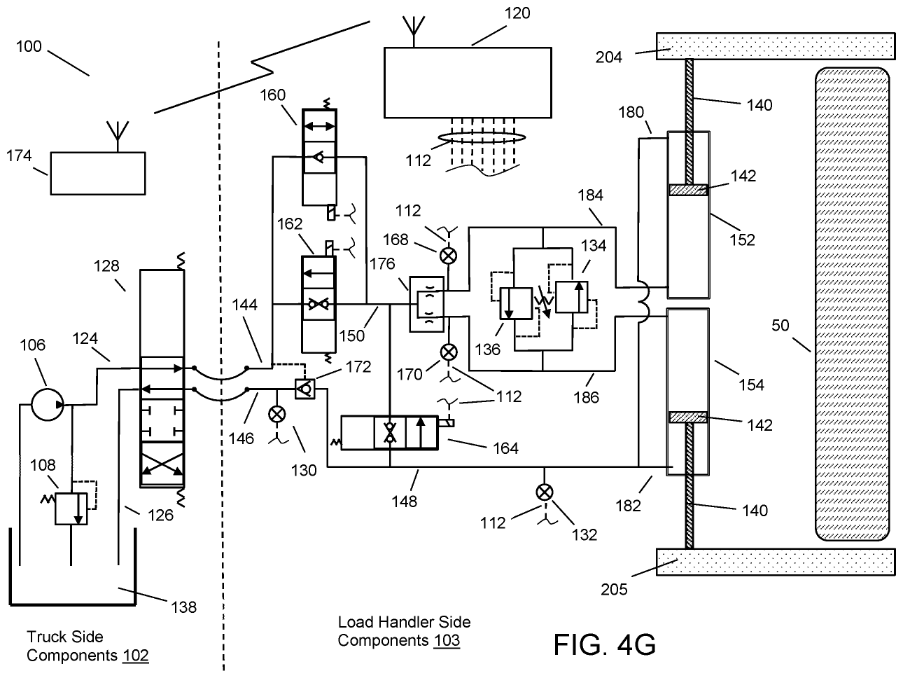

FIGS. 4A-4G each show a schematic view of a first representative embodiment of a smart clamp system 100, each in a different phase of operation for clamp and unclamping a load 50. The schematic is divided with truck side 102 components of the smart clamp system 100 on the left and load-handler side 103 components on the right. A first clamp hydraulic line 144 and a second clamp hydraulic line 146 cross over from the truck side 102 to the load-handler side 103 via flexible connections that have sufficient slack to handle the relative motion between the smart clamp load handler 104 and the lift truck 10. The smart clamp system has a control console 174 mounted on the lift truck 10. In some embodiments the control console 174 is mounted on the smart clamp load handler 104. In yet other embodiments, there is a first control console 174 on the lift truck 10 and a second control console 174 on the smart clamp load handler 104, each have some or all of the functions of the other.

On the truck side 102 of the schematic, the smart clamp system 100 has a hydraulic pump 106 to supply pressurized hydraulic fluid. The hydraulic pump 106 draws hydraulic fluid out of a hydraulic fluid reservoir 138. The hydraulic pump 106 is typically powered by the main engine of the lift truck 10 by belt or gear drives. The hydraulic pump 106 is typically a positive displacement pump. The outlet of the hydraulic pump 106 is connected to a relief valve 108 which regulates the pressure produced by the hydraulic pump 106 and provides a discharge path for excess hydraulic fluid that is not needed for the moment by the smart clamp system 100. The output of the hydraulic pump 106 couples to a truck hydraulic feed line 124. A truck hydraulic return line 126 brings hydraulic fluid back to the hydraulic fluid reservoir.

The smart clamp system 100 comprises a directional control valve 128, typically mounted as standard equipment to the lift truck 10. The directional control valve 128 is manually operated, but in some embodiments the directional control valve 128 may be a solenoid operated valve controlled by the controller 120 on the load-handler side 103 or a different controller on the truck side 102. The directional control valve 128 controls the direction of hydraulic fluid flow, which determines whether the clamp actuators 152, 154 move the clamp arms 204, 205 to open or to close. The directional control valve 128 is a three position, four port valve. When the directional control valve 128 is in a closed position, all four ports are blocked. When the directional control valve 128 is in a straight through position, a first input port of the directional control valve 128 (connected to the truck hydraulic feed line 124) is ported through a first output port to a first clamp hydraulic line 144, while a second input port of the directional control valve 128 (connected to the truck hydraulic return line 126) is ported through a second output port to the second clamp hydraulic line 146. When the directional control valve 128 is in a cross-over position, the first input port of the directional control valve 128 (connected to the truck hydraulic feed line 124) is ported through the second output port to the second clamp hydraulic line 146 and the second input port (connected to the truck hydraulic return line 126) is ported through the first output port to the first clamp hydraulic line 144. In other embodiments, the output ports could be swapped so that when the directional control valve 128 is in a cross-over position, the first input port of the directional control valve 128 (connected to the truck hydraulic feed line 124) is ported through the first output port to the first clamp hydraulic line 144, etc. and operations would be swapped as well.

On the load-handler side 103 of the schematic, the two clamp arms 204, 205 and the associated clamp actuators 152, 154 from FIG. 3 are shown. The clamp actuators 152, 154 are hollow tubes with capped ends, each having an actuator piston 142 inside coupled to an actuator rod 140 that passes through a sealed opening in one of the capped ends. Each of the clamp actuators 152, 154 is thus divided by the actuator piston 142 into a rod-side on which the actuator rod 140 is coupled to the actuator piston 142 and a base-side opposite. Each of the clamp actuators 152, 154 is thus divided into a rod-side chamber through which the actuator rod 140 passes and a base-side chamber opposite. In the first representative embodiment smart clamp system 100, the rod-side chamber is the opening chamber—the chamber that opens the clamp arms 204, 205 when hydraulic fluid is applied and the base-side is the closing chamber. However, in other embodiments, the base-side chamber may be the opening chamber, such as if the actuators 152, 154 were mounted outboard of the clamp arms 204, 205 and pushed to close them. The smart clamp load handler 104 also comprises a base-side control valve 160, a base-side blocking valve 162, a regeneration valve 164, an input pressure sensor 130, a rod-side pressure sensor 132, a first base-side pressure sensor 168, a second base-side pressure sensor 170, a main rod-side hydraulic line check valve 172, a first base equalization valve 134, a second base equalization valve 136 and a controller 120. In some alternative embodiments, one or more of these components may be located on the truck side 102.

The load-handler side 103 of the smart clamp system 100 has a main rod-side hydraulic line 148 and a main base-side hydraulic line 150. The main rod-side hydraulic line 148 splits into a first rod-side hydraulic line 180 and a second rod-side hydraulic line 182 (these three are collectively referred to as the “rod-side hydraulic lines”). The main base-side hydraulic line 150 splits into a first base-side hydraulic line 184 and a second base-side hydraulic line 186 (these three are collectively referred to as the “base-side hydraulic lines”). The first rod-side hydraulic line 180 hydraulically couples to the rod-side of the first clamp actuator 152, the second rod-side hydraulic line 182 hydraulically couples to the rod-side of the second clamp actuator 154, the first base-side hydraulic line 184 hydraulically couples to the base-side of the first clamp actuator 152, and the second base-side hydraulic line 186 hydraulically couples to the base-side of the second clamp actuator 154.

The base-side control valve 160, the base-side blocking valve 162, and the regeneration valve 164 are configured to stop the clamping operation when the controller 120 decides to do so based on its sensor input and logic/programming. The base-side control valve 160, the base-side blocking valve 162, and the regeneration valve 164 are solenoid operated, powered and controlled by the controller 120 over control wiring 112.

The base-side control valve 160 is a two position, two port valve with one input port and one output port. When in a first position (flow unblocked as shown in FIG. 4A), the base-side control valve 160 hydraulically couples the input port (connected to the first clamp hydraulic line 144) with the output port (connected to a main base-side hydraulic line 150). When in a second position (check valve as shown in FIG. 4D), the base-side control valve 160 hydraulically couples the input port (connected to the first clamp hydraulic line 144) with the output port (connected to the main base-side hydraulic line 150), but only allows flow from the first clamp hydraulic line 144 to the main base-side hydraulic line 150, but not in the reverse direction. In the first representative embodiment smart clamp system 100, the base-side control valve 160 is a poppet valve that in its first position it allows high flow, while in its second position it blocks flow with low leakage (less than would a spool valve).

The base-side blocking valve 162 is a two position, two port valve with one input port and one output port. When in a first position (flow blocked as shown in FIG. 4D), the base-side blocking valve 162 hydraulically blocks flow between the input port (connected to the first clamp hydraulic line 144) and the output port (connected to the main base-side hydraulic line 150). When in a second position (flow unblocked as shown in FIG. 4E), the base-side blocking valve 162 hydraulically couples the input port (connected to the first clamp hydraulic line 144) with the output port (connected to the main base-side hydraulic line 150). In the first representative embodiment smart clamp system 100, the base-side blocking valve 162 is a poppet valve, so when in the first position, it blocks flow with low leakage (less than would a spool valve) and when in the second position it allows low flow that can be modulated proportionally and with high accuracy. In some embodiments, the base-side blocking valve 162 in the second position only allows flow from the main base-side hydraulic line 150 to the first clamp hydraulic line 144, but not the reverse. In other embodiments, the base-side blocking valve 162 and the base-side control valve 160 may be replaced with a single three position poppet valve that in its first position is high flow and non-proportional, while in its second position it blocks flow with low leakage (less than would a spool valve) and when in its third position allows low flow that can be modulated proportionally with high accuracy. In other embodiments, the base-side control valve 160 is omitted and its functions taken over by the base-side blocking valve 162. In such a system, the clamp arms 204, 205 would move slower, particularly in the closing and opening phases of operation. In other embodiments, the base-side blocking valve 162 is a simple two-position valve with no modulation and an orifice in series to slow flow. In other embodiments, the base-side blocking valve 162 is a multi-position valve, with multiple flow positions in addition to the no flow position, each flow position with a different passage or orifice size.

The regeneration valve 164 is a two position, two port valve with one input port and one output port. When in a first position (flow blocked as shown in FIG. 4B), the regeneration valve 164 hydraulically blocks all flow between its input port (connected to the main rod-side hydraulic line 148) and its output port (connected to the main base-side hydraulic line 150). When in a second position (flow unblocked as shown in FIG. 4C), the regeneration valve 164 hydraulically couples the input port (connected to the main rod-side hydraulic line 148) with the output port (connected to the main base-side hydraulic line 150). In the smart clamp system 100, the regeneration valve 164, like the base-side blocking valve 162, is a poppet valve, so when in the first position, it blocks flow with low leakage (less than would a spool valve) and when in the second position it allows low flow that can be modulated proportionally with high accuracy. In some embodiments, the regeneration valve 164 in the second position ofnly allows flow from the main rod-side hydraulic line 148 to the main base-side hydraulic line 150, but not the reverse. In other embodiments, the regeneration valve 164 is a simple two-position valve with no modulation and an orifice in series to slow flow.

The main rod-side hydraulic line check valve 172 is a pilot operated check valve connecting the second clamp hydraulic line 146 with the main rod-side hydraulic line 148 and with a pilot tube to the first clamp hydraulic line 144. The main rod-side hydraulic line check valve 172 allows flow from the second clamp hydraulic line 146 to the main rod-side hydraulic line 148 in all circumstances, but only allows flow from the main rod-side hydraulic line 148 to the second clamp hydraulic line 146 if the pressure in the first clamp hydraulic line 144 is sufficient to cause the pilot operated check valve to lift. In the first representative embodiment smart clamp system 100, the main rod-side hydraulic line check valve 172 lifts if the pressure of the first clamp hydraulic line 144 is equal to or greater than ⅓ of the combined pressure of the second clamp hydraulic line 146 and the main rod-side hydraulic line 148. The main rod-side hydraulic line check valve 172 primarily serves to prevent pressurized hydraulic fluid in the main rod-side hydraulic line 148 from leaking out through the directional control valve 128 when it is in a neutral, (supposedly) no-flow position. However, there is usually some leakage through a typical directional control valve 128 when in a neutral position. Some alternative embodiments may omit the main rod-side hydraulic line check valve 172 if the smart clam load handler is to be used with a directional control valve 128 that has no or very minimal leakage when in the neutral position.

The first base equalization valve 134 is a differential pilot operated relief valve that has an input port coupled to the second base-side hydraulic line 186 and an output port coupled to the first base-side hydraulic line 184. The first base equalization valve 134 helps keep the movement of the clamp arms 204, 205 equal. The first base equalization valve 134 has a first pilot line that couples to the first base-side hydraulic line 184 and a second pilot line that couples to the second base-side hydraulic line 186. The first base equalization valve 134 is configured to block flow in its normal position and configured to open if the pressure in the second base-side hydraulic line 186 exceeds the pressure in the first base-side hydraulic line 184 by a predetermined amount. The predetermined amount it adjustable.

The second base equalization valve 136 is a differential pilot operated relief valve that has an input port coupled to the first base-side hydraulic line 184 and an output port coupled to the second base-side hydraulic line 186. The second base equalization valve 136 helps keep the movement of the clamp arms 204, 205 equal. The second base equalization valve 136 has a first pilot line that couples to the second base-side hydraulic line 186 and a second pilot line that couples to the first base-side hydraulic line 184. The second base equalization valve 136 is configured to block flow in its normal position and configured to open if the pressure in the first base-side hydraulic line 184 exceeds the pressure in the second base-side hydraulic line 186 by a predetermined amount. The predetermined amount it adjustable.

In the first representative embodiment smart clamp system 100, the first base equalization valve 134 and second base equalization valve 136 are combined in a single package as a dual equalization valve. In some alternative embodiments, the first base equalization valve 134 and the second base equalization valve 136 are omitted. In other embodiments, the first base equalization valve 134 and the second base equalization valve 136 are replaced with a different mechanism for equalizing pressure between the first base-side hydraulic line 184 and the second base-side hydraulic line 186.

The smart clamp system 100 has a flow divider 176 between the main base-side hydraulic line 150 and the base-side hydraulic line 184, 186. The flow divider 176 divides the flow equally between the first base-side hydraulic line 184 and the second base-side hydraulic line 186. The flow divider 176 helps keep the movement of the clamp arms 204, 205 equal.

The pressure sensors 130, 132, 168, 170 provide pressure measurements over control wiring 112 to the controller 120 for use in controlling the smart clamp load handler 104. The rod-side pressure sensor 132 is coupled to the main rod-side hydraulic line 148 downstream (towards the second clamp actuator 154) of the main rod-side hydraulic line check valve 172 and upstream (towards the hydraulic pump 106) of the second clamp actuator 154. The input pressure sensor 130 is coupled to the second clamp hydraulic line 146 downstream (towards the second clamp actuator 154) of the directional control valve 128 and upstream (towards the hydraulic pump 106) of the main rod-side hydraulic line check valve 172. The first base-side pressure sensor 168 is coupled to the first base-side hydraulic line 184 downstream (towards the first clamp actuator 152) of the flow divider 176, upstream (towards the hydraulic pump 106) of the first clamp actuator 152 and preferentially upstream of the base equalization valves 134, 136. The second base-side pressure sensor 170 is coupled to the second base-side hydraulic line 186 downstream (towards the second clamp actuator 154) of the flow divider 176, upstream (towards the hydraulic pump 106) of the second clamp actuator 154, and preferentially as close to the clamp actuators 152, 154 as possible.

In the first representative embodiment smart clamp system 100, the pressure sensors 130, 132, 168, 170 are pressure transducers that output a 4-20 mA signal that is converted in the controller 120 to a 0-3.3V signal that is interpreted by an analog to digital converter in the controller 120. Specifically, 0-3000 PSI (Hydraulic) translates to 0-5V transducer output, which is converted to 0-3.3V in the controller 120, which is converted to 0-2048 points by the analog to digital converter, which is interpreted as 0-3000 PSI in the microcontroller of the controller 120.

The controller 120 is configured with programming to control movement of the clamp arms 204, 205 and the force applied by them. The controller 120 programming is configured to change the positions of the valves 160, 162, 164 based on inputs from the pressure sensors 130, 132, 168, 170. The controller 120 is configured to have the first representative embodiment smart clamp system 100 apply multiple target levels of force to a load 50. The target levels may be set by authorized personnel, such as a facility manager, so that operators can only clamp to the levels of force programmed into the controller 120. In the representative embodiment, the controller 120 comprises a micro-controller architecture, but in alternative embodiments, the controller 120 may comprise hard-wired logic based, for example, on relays and/or transistors. In yet other embodiments, the controller 120 may comprise hydraulic logic utilizing hydraulic components, and utilizing a hydraulic working fluid such as air or oil. The control wiring 112 would then be hydraulic control lines instead of electrical conductors and the various automated valves would be hydraulically operated rather than solenoid operated.

The control console 174 has an electronic graphical touch screen display that shows various information regarding operation of the smart clamp system 100, including pressure, clamp force, indication of when the load is clamped and when the load is under-clamped. In some embodiments, the controller 120 has an electronic graphical touch screen display in addition or instead of the control console 174. The electronic graphical touch screen display is positioned to be visible to the operator when the smart clamp load handler 104 is at ground level or raised by the lift truck mast 12. In some embodiments the electronic graphical touch screen display is physically separate from, but communicatively coupled with the controller 120 and relocatable on the smart clamp load handler 104 to ensure visibility.

In some alternative embodiments, the flow divider 176, the second base-side pressure sensor 170, and the base equalization valves 134, 136 are omitted and there is only the first base-side pressure sensor 168, coupled to the main base-side hydraulic line 150.

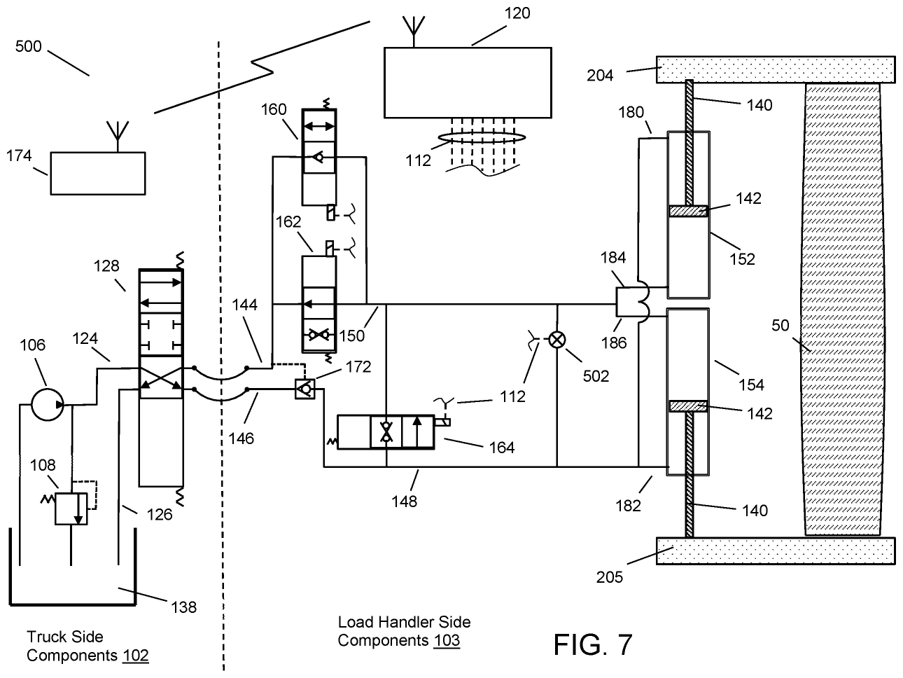

In some alternative embodiments, the base-side pressure sensors 168, 170 and the rod-side pressure sensor 132 may be replaced by a differential pressure sensor that measures differential pressure from the base-side to the rod-side (See differential pressure sensor 502 in FIG. 7). In some alternative embodiments, the differential pressure sensor can be replaced with one or more pressure switches. Each pressure switch would trigger repositioning of one or more of the valves 160, 162, 164 to a particular state, either directly or via controller 120 logic/programming.

In some alternative embodiments, the clamp actuators 152, 154 each have a load cell coupled thereto. The load cells measure the force applied by each of the clamp actuators 152, 154, which may be used to control operation of the first representative embodiment smart clamp system 100 in a similar manner to embodiments using forces calculated based on the base-side pressure sensors 168, 170 and the rod-side pressure sensors 132.

In some alternative embodiments, one or more frame deflection sensors are coupled to the frame 202 or to one or more clamp sliding beams 218 of the smart clamp load handler 104. The frame deflection sensors measure the deflection of the frame 202 caused by the force applied by each of the clamp actuators 152, 154, to the load 50, which may be used calculate the force on the load 50 control operation of the first representative embodiment smart clamp system 100 in a similar manner to embodiments using forces calculated based on the base-side pressure sensors 168, 170 and the rod-side pressure sensors 132.

In some alternative embodiments, the smart clamp load handler 104 has an orifice coupled between the first clamp hydraulic line 144 and the second clamp hydraulic line 146. This allows pressure to equalize between these two hydraulic lines when the directional control valve 128 is in a fully blocked position and equalize at a pressure below what is applied by the hydraulic pump 106 when the directional control valve 128 is in its straight flow or cross flow positions. This also gives additional volume into which hydraulic fluid can bleed when the first representative embodiment smart clamp system 100 is in a force adjustment phase. In some alternative embodiments, an additional pressure sensor, similar to the input pressure sensor 130, is coupled to the first clamp hydraulic line 144, to assist the controller 120 in determining flow direction. In some alternative embodiments, the orifice is replaced with a flow meter, which has a similar flow restricting quality, but will also provide an indication of the direction of flow to the controller 120 that can be used to determine which of the clamp hydraulic line 144, 146 has hydraulic pressure applied (i.e., the position of the directional control valve 128).

In some alternative embodiments, one of the clamp actuators 152, 154 may be omitted. In such embodiments, only one of the clamp arms 204, 205 moves and the other is fixed. In other alternative embodiments, one of the clamp arms 204, 205 moves under direct action of the actuator and the other moves by some mechanism that forces it to mirror the movements of the other clamp arm 204, 205. In single actuator embodiments, the flow divider 176 is also omitted, as are all the components between the flow divider 176 and the clamp actuators 152, 154.

### First Representative Embodiment—Method of Operation

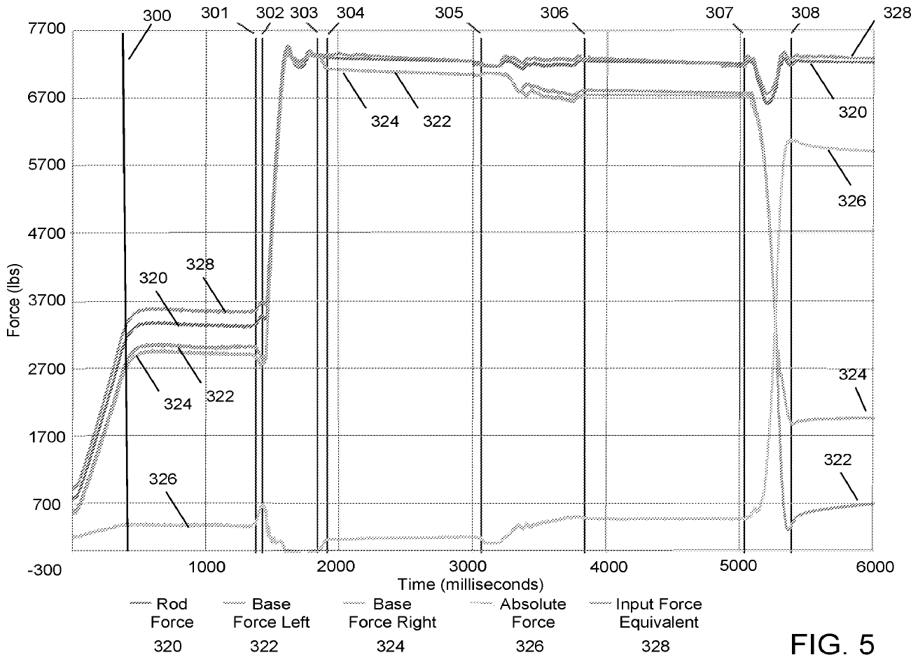

FIG. 5 shows a graph over time of the forces generated by the first representative embodiment smart clamp system 100 during clamping operations. The rod force line 320, calculated from pressure readings from the rod-side pressure sensor 132, traces the force on the rod-side of one of the actuator pistons 142 by hydraulic fluid pressure in the rod-side of one of the clamp actuators 152, 154. The base force left line 322, calculated from pressure readings from the first base-side pressure sensor 168, traces the force on the base-side of the actuator piston 142 by hydraulic fluid pressure in the base-side of the first clamp actuator 152. The base force right line 324, calculated from pressure readings from the first base-side pressure sensor 168, traces the force on the base-side of the actuator piston 142 by hydraulic fluid pressure in the base-side of the second clamp actuator 154. The absolute force line 326, calculated as the rod force minus the average of the two base forces, traces the force put on the load 50 by each of the clamp arms 204, 205. The input force equivalent line 328 is calculated as the input pressure (from the input pressure sensor 130) times the rod-side piston area of one of the clamp actuators 152, 154. It traces the amount of potential force available in the second clamp hydraulic line 146, if the pressure there were present in the rod-side of one of the clamp actuators 152, 154.

FIG. 4A shows a schematic of the first representative embodiment smart clamp system 100 in a fully open phase of operation (before time 0 in FIG. 5). The clamp arms 204, 205 are fully open and not in contact with the load 50. The directional control valve 128 is in a closed position with all four ports blocked. The base-side control valve 160 is first position (flow unblocked), the base-side blocking valve 162 is in its first position (flow blocked), and the regeneration valve 164 is in its first position (flow blocked).

FIG. 4B shows a schematic of a first representative embodiment smart clamp system in a closing phase of operation (time 0 to time 302 in FIG. 5). The closing phase of operation is commenced with the directional control valve 128 being put (usually by a human operator, but in some embodiments, by an electrical controller or other automated controller) in its cross-over position. Pressurized hydraulic fluid from the truck hydraulic feed line 124 flows into the second clamp hydraulic line 146, through the main rod-side hydraulic line check valve 172, through the main rod-side hydraulic line 148, through the first rod-side hydraulic line 180 and second rod-side hydraulic line 182 into the rod side of the first clamp actuator 152 and second clamp actuator 154. Hydraulic pressure builds in the rod side of the clamp actuators 152, 154, measured by the rod-side pressure sensor 132, until enough force is generated to overcome friction and the actuator pistons 142 move inward, moving the clamp arms 204, 205 towards each other and toward the load 50 (FIG. 5, time 0). Hydraulic fluid is forced out of the base side of the first clamp actuator 152 into the first base-side hydraulic line 184 and out of the base side of the second clamp actuator 154 into the second base-side hydraulic line 186. Pressure rises in the base-side hydraulic lines 184, 186, which is measured by the base-side pressure sensors 168, 170. Hydraulic fluid passes through the flow divider 176, through the main base-side hydraulic line 150, through the base-side control valve 160, through the first clamp hydraulic line 144, through the directional control valve 128, through the truck hydraulic return line 126 and into the hydraulic fluid reservoir 138. The controller 120 monitors pressures from the pressure sensors 132, 168, 170 and calculates a base-side to rod-side differential pressure. Initially, the rod-side pressure and the differential pressure rise, then the base-side pressure. The pressures then stabilize when clamp arms 204, 205 have reached the full speed that the system 100 is capable of supporting (FIG. 5, time 300) until the clamp arms 204, 205 contact the load 50 (FIG. 5, line 301). As movement of the clamp arms 204, 205 slows down and they begin to compress the load 50, the rod-side and differential pressures begin to rapidly rise, while the base-side pressures drops. When the controller 120 determines the clamp arms 204, 205 have contacted the load 50, it takes action to end the closing phase of operation and put the smart clamp system 100 in an equalization phase of operation. (See FIG. 5, line 302).

In the first representative embodiment smart clamp system 100, the controller 120 determines that contact has been made when the differential pressure is increasing faster than a predetermined threshold. In other embodiments, contact may be determined in other ways, such as differential pressure exceeding a preset threshold or using some other type of sensor. In some embodiments, one or more contact sensors on the clamp arms 204, 205 may be used, such as limit switches set in the faces of the clamp arms 204, 205 that close when they contact the load 50 or conductive contacts that detect contact with the load 50 when resistance between them changes. In some embodiments, one or more flow sensors placed in the main rod-side hydraulic line 148 and/or the base-side hydraulic lines 150, 184 , 186 can be used to detect contact based on when flow decreases in one or more of the lines faster than a predetermined value and/or decreases below a predetermined value.

FIG. 4C shows a schematic of a first representative embodiment smart clamp system 100 in an equalization phase of operation (time 302 to time 303 in FIG. 5). To put the smart clamp system 100 in the regenerative phase, the controller 120 sends signals to put the base-side control valve 160 in its second position (check valve) and the regeneration valve 164 in its second position (unblocked). The base-side blocking valve 162 remains in its first position (flow blocked). Hydraulic fluid quickly flows from the rod-side of the clamp actuators 152, 154, through the main rod-side hydraulic line 148, through the regeneration valve 164, through the main base-side hydraulic line 150. The hydraulic fluid is blocked by the check valve of the base-side control valve 160 and by the base-side blocking valve 162, so it flows though the flow divider 176 and into the base-side hydraulic lines 184, 186 and into the base-side of the clamp actuators 152, 154. The pressure in the base-side rises, dropping the differential pressure and causing the force applied to the load 50 to ease. If kept in equalization phase/configuration long enough the rod-side pressure will reach the maximum system pressure allowed by the relief valve 108. Due to the smaller surface area on the rod-side of the actuator pistons 142 compared to the base-side, if the differential pressure were to equalize, the clamp arms 204, 205 would start to move away from the load 50. However, before that happens, the controller 120 ends the equalization phase of operations, triggered by differential pressure dropping below a predetermined threshold. Alternatively, the end of the equalization phase can be triggered by the rod-side pressure sensor 132 reaching a threshold at or almost at the maximum system pressure allowed by the relief valve 108 (FIG. 5, line 303).

FIG. 4D shows a schematic of a first representative embodiment smart clamp system 100 at the end of the equalization phase of operation (at time 303 in FIG. 5). The regeneration valve 164 has changed back to the first position, blocking flow from the main rod-side hydraulic line 148 to the main base-side hydraulic line 150. The hydraulic pump 106 and relief valve 108 maintain pressure in the rod-side at the maximum level. Pressure remains stable in the base-side at a level slightly less than the rod-side, the differential pressure between the rod-side and base-side balancing off the difference between the areas of the base-sides of the actuator pistons 142 and their rod-sides so the forces applied on them are in balance and the clamp arms 204, 205 do not move. Since pressure in both the rod-side and the base-side are nearly at the maximum level, the hydraulic fluid is highly compressed and the hydraulic lines are expanded by pressure, which provide the reserve of energy to apply increasing force in the following phases of operation.

FIG. 4E shows a schematic of a first representative embodiment smart clamp system 100 in a force adjustment phase of operation (time 303 to time 304 in FIG. 5). The controller 120 sends a signal to change the base-side blocking valve 162 to its second (unblocked) position. Hydraulic fluid bleeds out from the base-side hydraulic lines 150, 184, 186. Pressure drops on the base-side while remaining higher on the rod-side, increasing differential pressure and increasing the force applied by the clamp arms 204, 205 and further compressing the load 50. The controller 120 calculates the force applied based on the pressure measurements and when the force applied by the clamp arms 204, 205 reaches one of the target levels programmed into the controller 120, then the controller 120 changes the base-side blocking valve 162 to its first (blocked) position (FIG. 5, time 304). If the force applied overshoots the target level, the regeneration valve 164 can be put in its second position (unblocked) to reduce differential pressure (and force applied). In some embodiments, the controller 120 is configured to modulate the base-side blocking valve 162 based on how close the force applied is to the target force level so that the target force level can be achieved with more accuracy. In this first force adjustment phase of operation, shown from time 303 to time 304 in FIG. 5, only a small adjustment is made in the force applied so there is little transient response.

FIG. 4F shows a schematic of a first representative embodiment smart clamp system 100 in a clamped phase of operation (e.g. time 304 to time 305 in FIG. 5). Once the clamp arms 204, 205 have clamped on to the load 50 and are applying a force equal to one of the target levels, the controller 120 sends a signal to the control console 174 indicating to the operator that a first target level of force has been applied. The operator then releases the directional control valve 128 back to the neutral, fully blocked position. Hydraulic fluid slowly leaks past the base-side blocking valve 162 and the base-side control valve 160, slowly dropping base-side pressure, increasing differential pressure and force applied from time 304 to time 305.

If the lift truck operator wants to increase the force applied to a second target level, then the operator can put the directional control valve 128 again into the cross-flow position. If clamp input pressure (as measured by input pressure sensor 130) is greater than the base-side pressure (as measured by the base-side pressure sensors 168, 170), then the controller 120 will repeat another force adjustment phase of operation (time 305 to time 306 in FIG. 5) putting the base-side blocking valve 162 to its second (unblocked) position (time 305) until the second target force level has been achieved (time 306). The operator then releases the directional control valve 128 back to the neutral position. In this second force adjustment phase of operation, shown from time 305 to time 306 in FIG. 5, a larger adjustment is made in the force applied which results in an overdamped transient response.

If the lift truck operator wants to increase the force applied to a third target level, then the force adjustment phase of operation can be repeated again (time 307 to time 308 in FIG. 5) and for as many force levels as have been programmed into the controller 120. In this third force adjustment phase of operation, shown from time 307 to time 308 in FIG. 5, an even larger adjustment is made in the force applied which results in an underdamped transient response.

Once the desired force level has been applied to the load 50, the lift truck operator then operates other controls to lift the carriage 14 along with the smart clamp load handler 104 and load 50 and then move the load 50 to a new location.

While the load 50 is still in the clamped phase, differential pressure may change over time, possibly due to imperfect seals in components such as the actuator pistons 142, the base-side blocking valve 162 or the regeneration valve 164, changing the force applied to the load 50. If the controller 120 determines the forced applied has increased more than a predetermined threshold, it is configured to put the regeneration valve 164 in its second position (flow unblocked) until it determines the target force level has been restored. If the controller 120 determines the force applied has dropped more than a predetermined threshold, it is configured to put the base-side blocking valve 162 in its second position (flow unblocked) until it determines the target force level has been restored. The first clamp hydraulic line 144 should be empty or nearly empty right after the initial clamping, so a small volume can flow out of the main base-side hydraulic line 150 and into the first clamp hydraulic line 144. If the first clamp hydraulic line 144 fills up and unblocking the base-side blocking valve 162 fails to restore the applied force to the target level, then the controller 120 can send a signal to the control console 174 to display an indication that differential pressure is low and the operator should put the directional control valve 128 in the cross-flow position until rod-side pressure is restored.

FIG. 4G shows a schematic of a first representative embodiment smart clamp system 100 in an opening phase of operation (not shown on FIG. 5 graph). Once the load 50 has been placed in a desired location, the lift truck operator puts the directional control valve 128 into the flow through position. The hydraulic pump 106 applies hydraulic fluid and pressure to the first clamp hydraulic line 144, opening the main rod-side hydraulic line check valve 172 and allowing hydraulic fluid to drain from the rod-side into the hydraulic fluid reservoir 138, dropping the pressure on the rod-side. The residual pressure on the base-side begins to move the clamp arms 204, 205 apart. Hydraulic fluid flows through the check valve of the base-side control valve 160, bolstering pressure on the base-side. Once the operator has released the directional control valve 128 and returned it to the fully blocked position, the clamp arms 204, 205 stop moving and the rod-side and base-side pressures stabilize. In the first representative embodiment smart clamp system 100, if the pressure measured by the input pressure sensor 130 is less than the pressure measured by the rod-side pressure sensor 132 and if pressure measured by the base-side pressure sensors 168, 170 is higher than the pressure measured by the rod-side pressure sensor 132 for at least a short period of time (e.g. 200 milliseconds) then the controller 120 will put the base-side control valve 160 in the first (unblocked) position, putting the smart clamp system 100 back in the open phase of operation (FIG. 4A) and ready for another closing phase. In other embodiments, other conditions may be used to trigger putting the smart clamp system 100 back in the open phase of operation.

### Second Representative Embodiment—Structure

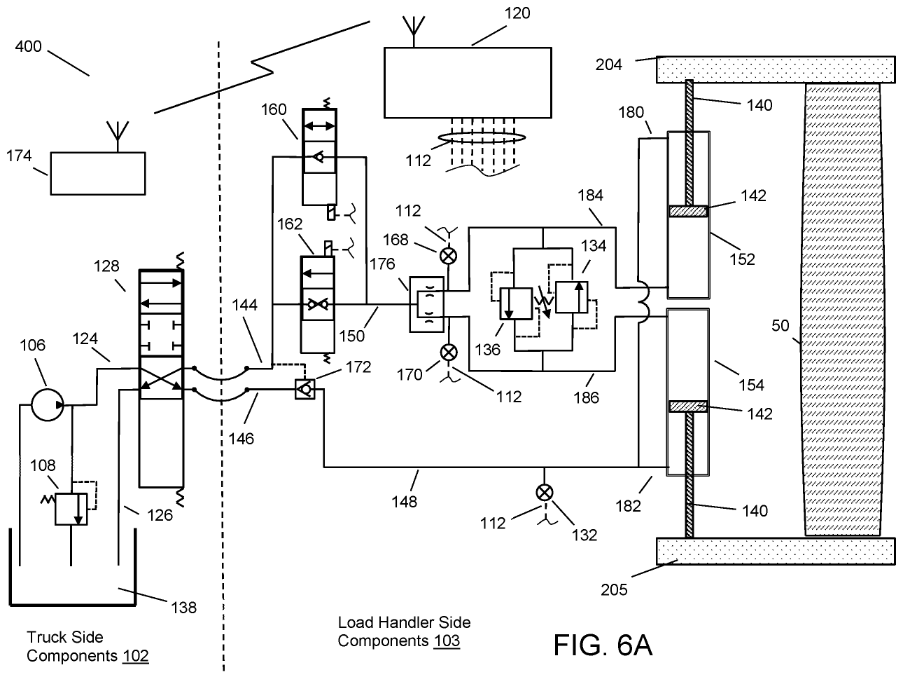

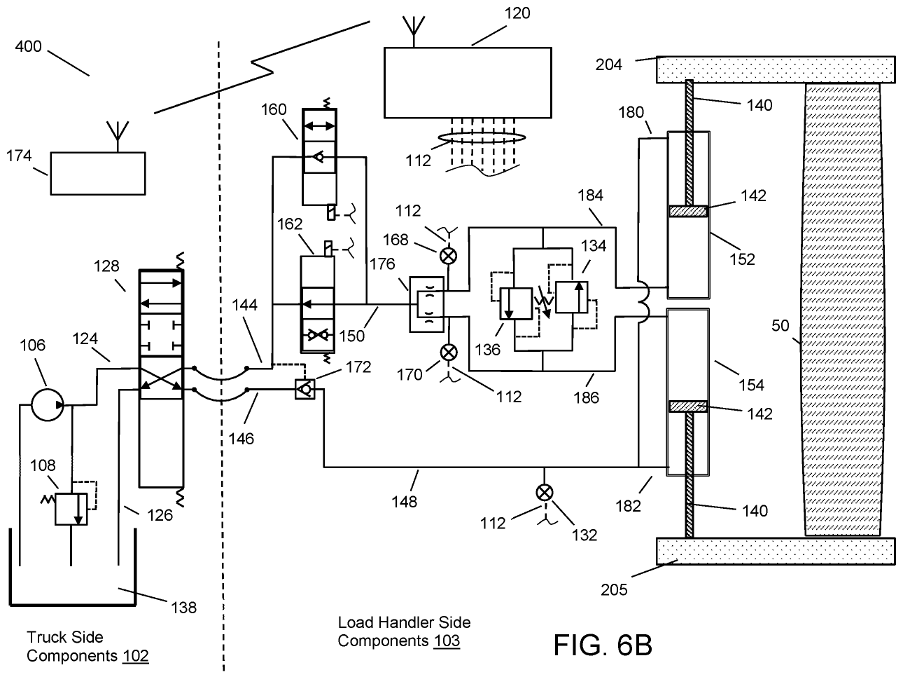

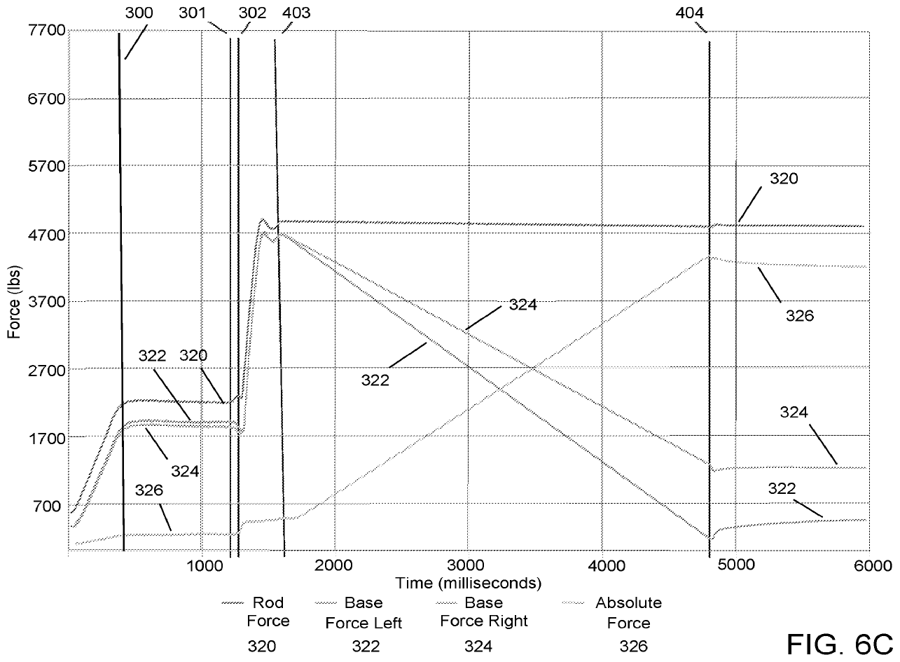

FIGS. 6A and 6B show a schematic of a second representative embodiment smart clamp system 400. The second representative embodiment smart clamp system 400 has the same structure and operation as described for the first representative embodiment smart clamp system 100, except as noted here. Alternative embodiments described for the first representative embodiment smart clamp system 100 may apply to the second representative embodiment smart clamp system 400. The second representative embodiment smart clamp system 400 omits the regeneration valve 164 and the input pressure sensor 130. Most of the advantages of the system would remain, but the advantages of regeneration would be lost. There would be no automated reduction of differential pressure (and force applied) such that occurs in the clamped phase of operation (time 304 to time 305 in FIG. 5) of the first representative embodiment smart clamp system 100.

In some alternative embodiments, the base-side blocking valve 162 may be omitted altogether, along with the rod-side pressure sensor 132. Additionally, the first base-side pressure sensor 168 and second base-side pressure sensor 170 may be replaced with a single base-side pressure sensor coupled to the main base-side hydraulic line 150. During the closing phase of operation, the base-side control valve 160 starts in its first (flow through) position, but the controller 120 puts the base-side control valve 160 in its second position (check valve) when base-side pressure exceeds a first target pressure level. After the base-side pressure has achieved steady state (within a predetermined range), the base-side control valve 160 is put in its first position (flow through) until base-side pressure drops below a second target pressure level. The process may be repeated for as many target pressure levels as are set in the programming/logic of the controller 120. The operator in the lift truck 10 is notified of the current base-side pressure level via the control console 174 or other type of instrumentation. The operator moves the directional control valve 128 to the neutral (fully blocked) position when satisfied with the level of pressure/force applied to the load 50.

### Second Representative Embodiment—Method of Operation

FIG. 6C shows a graph over time of the forces generated by the second representative embodiment smart clamp system 400 during clamping operations. The lines traced out are defined the same as they are in FIG. 5 for the first representative embodiment smart clamp system 100, except there is no input force equivalent line 328 since the input pressure sensor 130 is omitted. The fully open phase of operation (time 0 and before in FIGS. 5 and 6C) is the same in the second representative embodiment smart clamp system 400 as in the first representative embodiment smart clamp system 100. The closing phase of operation (time 0 to time 300 to time 302 in FIGS. 5 and 6C) is the same as well.

However, the second representative embodiment smart clamp system 400 does not have an equalization phase of operation (time 302 to time 303 in FIG. 5) followed by a force adjustment phase of operation (time 303 to time 304 in FIG. 5) as does the first representative embodiment smart clamp system 100. Instead, the second representative embodiment smart clamp system 400 enters an equalization phase of operation (time 302 to time 403 in FIG. 6C) followed by a slow adjustment phase of operation (time 403 to time 404 in FIG. 6C).

FIG. 6A shows a schematic of a second representative embodiment smart clamp system 400 in an equalization phase of operation (time 302 to time 403 in FIG. 6C). To put the second representative embodiment smart clamp system 400 in the equalization phase, the controller 120 sends signals to put the base-side control valve 160 in its second position (check valve). The base-side blocking valve 162 remains in its first position (flow blocked). The hydraulic fluid in the base-side of the clamp actuators 152, 154 can no longer flow out to the hydraulic fluid reservoir 138 as it is blocked by the check valve of the base-side control valve 160 and by the base-side blocking valve 162. The pressure in the rod-side rises and pressure in the base-side rises almost as much. The differential pressure increases slightly, causing the force applied to the load 50 to increase slightly. If kept in equalization phase/configuration long enough the differential pressure will stabilize at a level slightly larger than when the base-side control valve 160 closed to its flow blocking check valve position. The controller 120 ends the equalization phase of operations triggered by the rod-side pressure sensor 132 reaching a threshold that may be at or almost at the maximum system pressure allowed by the relief valve 108.

FIG. 6B shows a schematic of a second representative embodiment smart clamp system 400 in a slow adjustment phase of operation (time 403 to time 404 in FIG. 6C). The controller 120 sends a signal to change the base-side blocking valve 162 to its second (unblocked) position. Hydraulic fluid bleeds out from the base-side hydraulic lines 150, 184, 186. Pressure drops on the base-side while remaining higher on the rod-side, increasing differential pressure and increasing the force applied by the clamp arms 204, 205 and further compressing the load 50. The controller 120 calculates the force applied based on the pressure measurements and when the force applied by the clamp arms 204, 205 reaches one of the target levels programmed into the controller 120, the controller 120 sends an indication to the operator that the particular target level has been reached, typically via the control console 174. The slow adjustment phase continues until the operator returns the directional control valve 128 to the closed position. If the lift truck operator wants to increase the force applied, then the operator can put the directional control valve 128 again into the cross-flow position. Once the desired force level has been applied to the load 50, the lift truck operator then operates other controls to lift the carriage 14 along with the smart clamp load handler 104 and load 50 and then move the load 50 to a new location.

The opening phase of operation is the same in the second representative embodiment smart clamp system 400 as in the first representative embodiment smart clamp system 100.

### Third Representative Embodiment

FIG. 7 shows a schematic of a third representative embodiment smart clamp system 500 in a force adjustment phase of operation. The third representative embodiment smart clamp system 500 has the same structure and operation as described for the first representative embodiment smart clamp system 100, excepted as noted here. Alternative embodiments described for the first representative embodiment smart clamp system 100 may apply to the third representative embodiment smart clamp system 500. The third representative embodiment smart clamp system 500 omits the flow divider 176, and the base equalization valves 134, 136. This is a less expensive embodiment, but some ability to maintain even movement of the clamp arms 204, 205 is lost. The rod-side pressure sensor 132 and the base-side pressure sensors 168, 170 are replaced with a differential pressure sensor 502 coupled between the main rod-side hydraulic line 148 and the main base-side hydraulic line 150. The input pressure sensor 130 is omitted. This is less expensive, but the controller 120 must rely entirely on the differential pressure for making decisions rather than also using the input pressure, the rod-side pressure and the base-side pressure, which results in some loss of precision and consistency in performance.

In the opening phase of operation, the condition for putting the base-side control valve 160 in the first (unblocked) position is different. In the third representative embodiment smart clamp system 500, if the differential pressure measured by the differential pressure sensor 502 is negative (base side larger than rod side) for at least a short period of time (e.g. 200 milliseconds) then the controller 120 will put the base-side control valve 160 in the first (unblocked) position, putting the third representative embodiment smart clamp system 500 back in the open phase of operation and ready for another closing phase.

The third representative embodiment smart clamp system 500 loses the ability to advance from one target force level to another in the clamped phase of operations by moving the directional control valve 128 from the neutral to the cross-flow position as there is no way to determine if input pressure is greater than base-side pressure. Instead, the operator uses the control console 174 to command the third representative embodiment smart clamp system 500 to advance to another target force level. In other embodiments, other suitable mechanisms can be used to advance to another target force level.

In some alternative embodiments, the differential pressure sensor 502 can be replaced with one or more pressure switches. Each pressure switch would trigger repositioning of one or more of the valves 160, 162, 164 to a particular state, either directly or via controller 120 logic/programming.

### Fourth Representative Embodiment

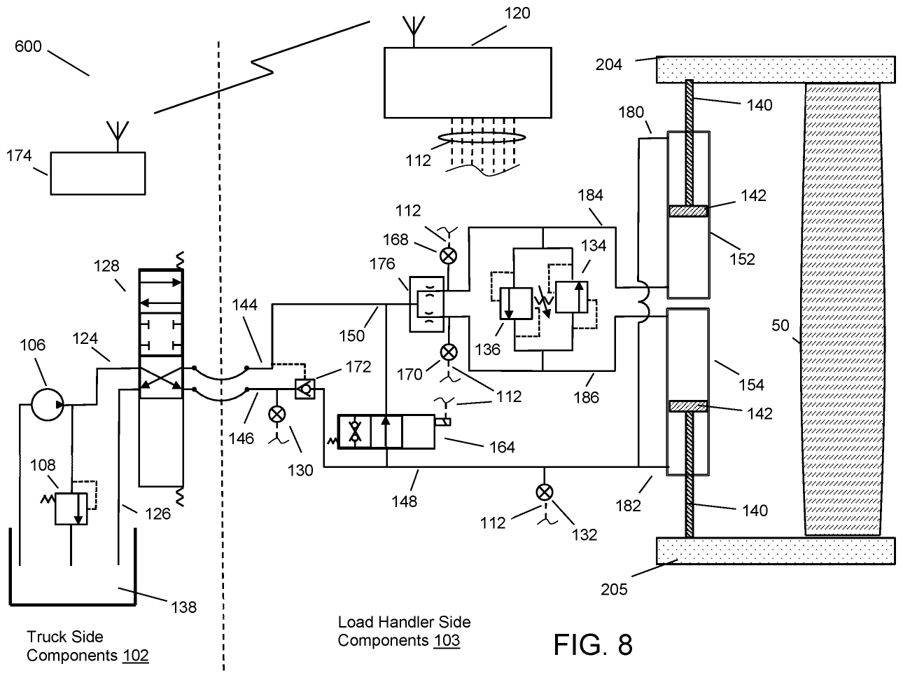

FIG. 8 shows a schematic of a fourth representative embodiment smart clamp system 600 in an equalization phase of operation. The fourth representative embodiment smart clamp system 600 has the same structure and operation as described for the first representative embodiment smart clamp system 100, excepted as noted here. Alternative embodiments described for the first representative embodiment smart clamp system 100 may apply to the fourth representative embodiment smart clamp system 600. The fourth representative embodiment smart clamp system 600 omits the base-side control valve 160 and the base-side blocking valve 162. This is a less expensive embodiment, but gives up most of the precision and accuracy of the first representative embodiment smart clamp system 100. After contact detection (rising differential pressure, dropping base-side pressure), the regeneration valve 164 can be opened and modulated to achieve the target level force applied. If the force applied is too low, the regeneration valve 164 can be modulated to close more, allowing less flow and pressure to the base-side. If the force applied is to high, the regeneration valve 164 can be modulated to open more, allowing more flow and pressure to the base-side. The fourth representative embodiment smart clamp system 600 would not charge to the maximum pressure allowed by the relief valve 108, but instead would dynamically adjust the regeneration valve 164 constantly keeping the force applied to the load 50 at target level until the directional control valve 128 is put back in the neutral (flow blocked) position.

Similar to the third representative embodiment smart clamp system 500, the fourth representative embodiment smart clamp system 600 loses the ability to advance from one target force level to another in the clamped phase of operations by moving the directional control valve 128 from the neutral to the cross-flow position as there is no way to determine if input pressure is greater than base-side pressure. Instead, the operator uses the control console 174 to command the fourth representative embodiment smart clamp system 600 to advance to another target force level. In other embodiments, other suitable mechanisms can be used to advance to another target force level.

### Fifth Representative Embodiment—Structure

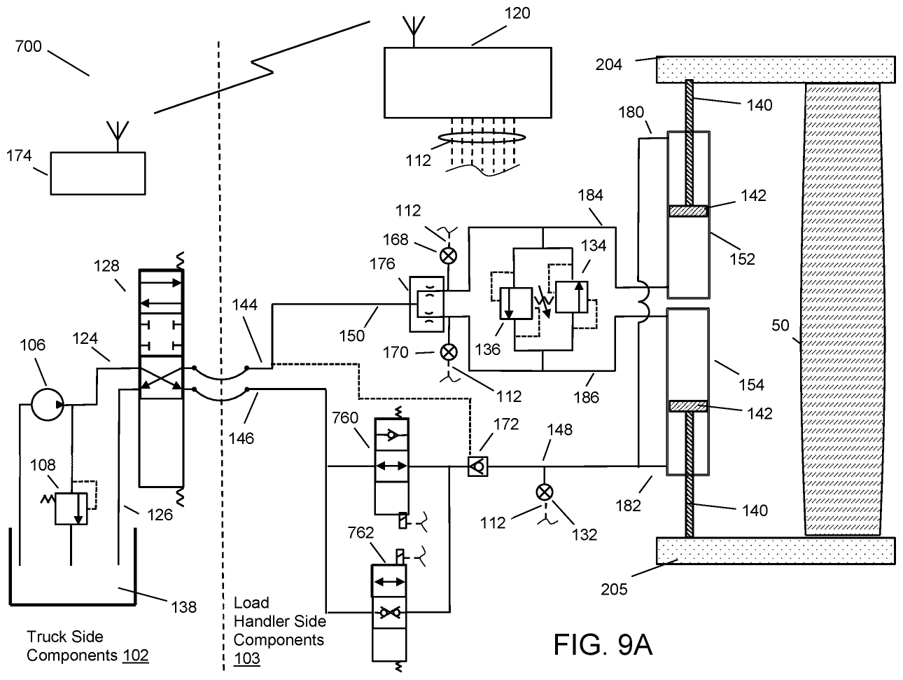

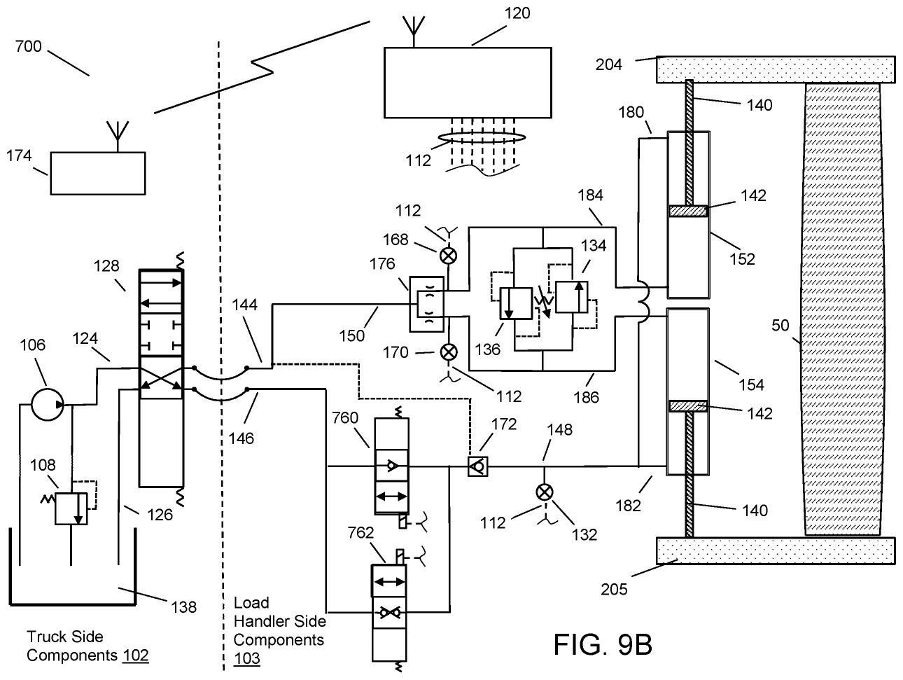

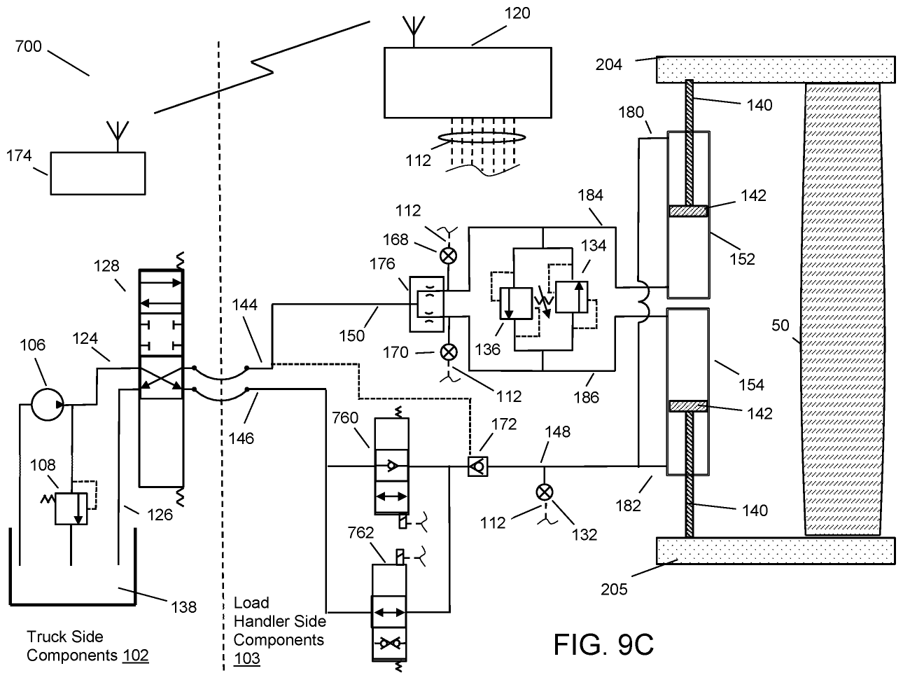

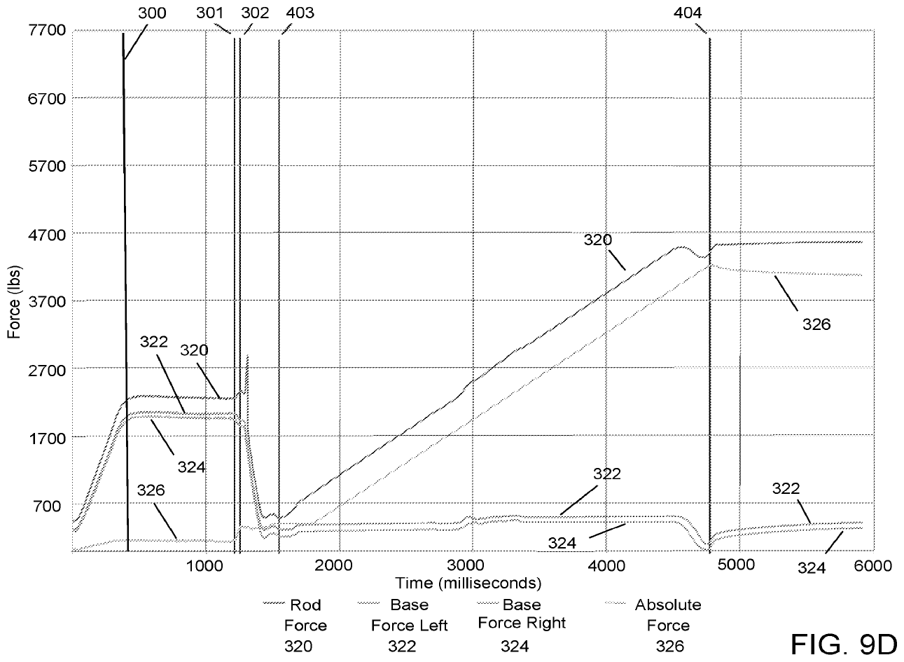

FIGS. 9A, 9B, and 9C show a schematic of a fifth representative embodiment smart clamp system 700. The fifth representative embodiment smart clamp system 700 has the same structure and operation as described for the first representative embodiment smart clamp system 100, excepted as noted here. Alternative embodiments described for the first representative embodiment smart clamp system 100 may apply to the fifth representative embodiment smart clamp system 700. The fifth representative embodiment smart clamp system 700 omits the input pressure sensor 130, the regeneration valve 164, the base-side control valve 160 and the base-side blocking valve 162. Instead, the fifth representative embodiment smart clamp system 700 has a rod-side control valve 760 and a rod-side blocking valve 762 configured in parallel in line with the main rod-side hydraulic line 148 between the second clamp hydraulic line 146 and the main rod-side hydraulic line check valve 172. The rod-side control valve 760 and the rod-side blocking valve 762 are structurally similar to the base-side control valve 160 and the base-side blocking valve 162 respectively and have similar operational characteristics. The alternatives and options mentioned for the base-side control valve 160 and the base-side blocking valve 162 may be used with the rod-side control valve 760 and rod-side blocking valve 762 as well.

In some alternative embodiments, the rod-side blocking valve 762 may be replaced with a fixed orifice. This will reduce cost and complexity. Since the rod-side blocking valve 762 is upstream (towards the hydraulic pump 106) from the main rod-side hydraulic line check valve 172, it is not needed to block flow out of the rod-side to maintain the base end pressure after hydraulic pressure from the hydraulic pump 106 is removed (typically by putting the directional control valve 128 in its fully block or straight flow positions) as the main rod-side hydraulic line check valve 172 will do that.

In some alternative embodiments, the rod-side blocking valve 762 may be omitted altogether, along with the first base-side pressure sensor 168 and the second base-side pressure sensor 170. During the closing phase of operation, the controller 120 puts the rod-side control valve 760 in its second position (check valve) when rod-side pressure (measured by rod-side pressure sensor 132) exceeds a first target pressure level. After the rod-side pressure has achieved steady state (within a predetermined range), the rod-side control valve 760 is put in its first position (flow through) until rod-side pressure exceeds a second target pressure level. After the rod-side pressure has achieved steady state (within a predetermined range), the rod-side control valve 760 is put in its first position (flow through) until rod-side pressure exceeds a third target pressure level. The process may be repeated for as many target pressure levels as are set in the programming/logic of the controller 120. The operator in the lift truck 10 is notified of the current rod-side pressure level or force applied to the load 50 (derived from the rod-side pressure) via the control console 174 or other type of instrumentation. The operator moves the directional control valve 128 to the neutral (fully blocked) position when satisfied with the level of pressure/force applied to the load 50. Anytime the controller 120 detects that rod-side pressure has dropped below a low pressure threshold, then the rod-side control valve 760 is put in the first position (flow through) as this indicates that the clamp arms 204, 205 are not in contact with the load 50.

### Fifth Representative Embodiment—Method of Operation

FIG. 9D shows a graph over time of the forces generated by the fifth representative embodiment smart clamp system 700 during clamping operations. The lines traced out are defined the same as they are in FIG. 5 for the first representative embodiment smart clamp system 100, except there is no input force equivalent line 328 since the input pressure sensor 130 is omitted.

When the fifth representative embodiment smart clamp system 700 is in a fully open phase of operation (before time 0 in FIG. 9D), the clamp arms 204, 205 are fully open and not in contact with the load 50. The directional control valve 128 is in a closed position with all four ports blocked. The rod-side control valve 760 is its first position (flow unblocked), rod-side blocking valve 762 is in its first position (flow blocked).

FIG. 9A shows a schematic of the fifth representative embodiment smart clamp system 700 in a closing phase of operation (time 0 to time 302 in FIG. 9D). The closing phase of operation is commenced with the directional control valve 128 being put (usually by a human operator, but in some embodiments, by an electrical controller or other automated controller) in its cross-over position. Pressurized hydraulic fluid from the truck hydraulic feed line 124 flows into the second clamp hydraulic line 146, through the main rod-side hydraulic line 148, through the rod-side control valve 760, through the main rod-side hydraulic line check valve 172, through the first rod-side hydraulic line 180 and second rod-side hydraulic line 182 into the rod side of the first clamp actuator 152 and second clamp actuator 154. Hydraulic pressure builds in the rod side of the clamp actuators 152, 154, measured by the rod-side pressure sensor 132, until enough force is generated to overcome friction and the actuator pistons 142 move inward, moving the clamp arms 204, 205 towards each other and toward the load 50 (FIG. 9D, time 0). Hydraulic fluid is forced out of the base side of the first clamp actuator 152 into the first base-side hydraulic line 184 and out of the base side of the second clamp actuator 154 into the second base-side hydraulic line 186. Pressure rises in the base-side hydraulic lines 184, 186, which is measured by the base-side pressure sensors 168, 170. Hydraulic fluid passes through the flow divider 176, through the main base-side hydraulic line 150, through the first clamp hydraulic line 144, through the directional control valve 128, through the truck hydraulic return line 126 and into the hydraulic fluid reservoir 138. The controller 120 monitors pressures from the pressure sensors 132, 168, 170 and calculates a base-side to rod-side differential pressure. As the clamp arms 204, 205 first start to move, rod-side and differential pressures rise, then the base-side pressures. The pressures then stabilize when clamp arms 204, 205 have reached the full speed that the system 100 is capable of supporting (FIG. 9D, time 300) until the clamp arms 204, 205 contact the load 50. (FIG. 9D, line 301). As movement of the clamp arms 204, 205 slows down and they begin to compress the load 50, the rod-side pressure rises, while the base-side pressures drops, causing the differential pressure to rapidly increase. When the controller 120 determines the clamp arms 204, 205 have contacted the load 50, it takes action to end the closing phase of operation and put the smart clamp system 100 in an equalization phase of operation (time 302 to time 403 in FIG. 9D).

FIG. 9B shows a schematic of a fifth representative embodiment smart clamp system 700 in an equalization phase of operation (time 302 to time 403 in FIG. 9D). To put the fifth representative embodiment smart clamp system 700 in the equalization phase, the controller 120 sends signals to put the rod-side control valve 760 in its second position (check valve). The rod-side blocking valve 762 remains in its first position (flow blocked). The pressure in the rod-side then drops rapidly since it is cut off from the hydraulic pump 106. The hydraulic fluid in the base-side of the clamp actuators 152, 154 continues to flow out through the flow divider 176 to the hydraulic fluid reservoir 138 causing the pressure in the base-side to drop rapidly as well, largely matching the drop in rod-side pressure, so the differential pressure and the force applied to the load remains substantially the same. The controller 120 ends the equalization phase of operations, triggered by rod-side and/or base-side pressure dropping below a predetermined threshold, transitioning to a slow adjustment phase of operation.

FIG. 9C shows a schematic of a fifth representative embodiment smart clamp system 700 in the slow adjustment phase of operation (time 403 to time 404 in FIG. 9D). The controller 120 sends a signal to change the rod-side blocking valve 762 to its second (unblocked) position. The rod-side blocking valve 762 has a smaller passage in its unblocked position than the rod-side control valve 760, so pressure increases gradually on the rod-side. Hydraulic fluid bleeds out from the base-side hydraulic lines 150, 184, 186. Only a small amount of pressure remains on the base-side, just the amount of pressure needed to push the hydraulic fluid displaced from the base-side of the clamp actuators 152, 154 through the flow divider 176 and the base-side hydraulic lines 184, 186, 150. The controller 120 calculates the force applied based on the pressure measurements and when the force applied by the clamp arms 204, 205 reaches one of the target levels programmed into the controller 120, then the controller 120 sends an indication to the operator that the particular target level has been reached, typically via the control console 174. The slow adjustment phase continues until the operator returns the directional control valve 128 to the closed position. If the lift truck operator wants to increase the force applied, then the operator can put the directional control valve 128 again into the cross-flow position. Once the desired force level has been applied to the load 50, the lift truck operator then operates other controls to lift the carriage 14 along with the smart clamp load handler 104 and load 50 and then move the load 50 to a new location.

What is claimed is:

1. A smart clamp load handler comprising:
a first clamp arm and a second clamp arm;
one or more actuators coupled to the clamp arms, wherein each of the one or more actuators have a closing actuator chamber and an opening actuator chamber;
a first clamp hydraulic line hydraulically coupled to the one or more opening actuator chambers;
a second clamp hydraulic line hydraulically coupled to the one or more closing actuator chambers;
a control valve hydraulically coupled between the first clamp hydraulic line and the opening actuator chambers;
a first pressure sensor configured to sense hydraulic pressure applied to at least one of the one or more opening actuator chambers; and
a controller configured for controlling an amount of force applied by the clamp arms to a target level by changing positions of the control valve, based on pressure measurements from the first pressure sensor.

2. The smart clamp load handler of claim 1, further comprising:
wherein the one or more actuators are configured for opening of the clamp arms when hydraulic fluid expands the one or more opening actuator chambers;
wherein the one or more actuators are configured for closing of the clamp arms when hydraulic fluid expands the one or more closing actuator chambers; and
wherein the first and second clamp hydraulic lines are configured to be coupled to a lift truck.

3. The smart clamp load handler of claim 1, further comprising:
a blocking valve hydraulically coupled in parallel with the control valve;
a second pressure sensor configured to sense hydraulic pressure applied to the one or more closing actuator chambers; and
wherein the controller is configured for controlling the amount of force applied by the clamp arms to a target level by changing positions of the control valve and the blocking valve, based on pressure measurements from the first pressure sensor and the second pressure sensor.

4. The smart clamp load handler of claim 3, wherein the controller is further configured for controlling the amount of force applied by the clamp arms to a target level by:
determining the amount of force applied by the clamp arms to a load based on the pressure measurements;
if in a closing phase and contact between the load and the clamp arms has been detected, then entering an equalization phase by putting the control valve in its check valve position;
if in the equalization phase and hydraulic pressure applied to the one or more closing actuator chambers reaches a first pressure threshold, then entering a slow adjustment phase by putting the blocking valve in its unblocked position; and
if in the slow adjustment phase and the force applied is determined to have reached a first target force level, then sending an indication to a control console that the first target force level has been reached.

5. The smart clamp load handler of claim 4, wherein the controller is configured for determining when contact between the load and the clamp arms has been detected by:
determining a differential pressure between the one or more opening actuator chambers and the one or more closing actuator chambers based on the pressure measurements; and
determining the differential pressure is increasing faster than a differential pressure rate of change threshold.

6. The smart clamp load handler of claim 3, further comprising:
a regeneration valve hydraulically coupled between the closing actuator chambers and the opening actuator chambers;
an input pressure sensor configured to sense hydraulic pressure applied to the second clamp hydraulic line; and
wherein the controller is configured for controlling the amount of force applied by the clamp arms to a target level by changing positions of the control valve, the blocking valve, and the regeneration valve, based on pressure measurements from the first pressure sensor, the second pressure sensor, and the input pressure sensor.

7. The smart clamp load handler of claims 3 and 6, further comprising:
a pilot operated check valve hydraulically coupled between the second clamp hydraulic line and the one or more opening actuator chambers with a pilot tube to the first clamp hydraulic line.

8. The smart clamp load handler of claim 6,
a pilot operated check valve hydraulically coupled between the second clamp hydraulic line and the one or more opening actuator chambers with a pilot tube to the first clamp hydraulic line;
wherein the control valve is configured for, when in a first position, allowing flow of hydraulic fluid between the first clamp hydraulic line and the one or more opening actuator chambers and configured for, when in a second position, allowing flow from the first clamp hydraulic line to the one or more opening actuator chambers, but checking flow from the one or more opening actuator chambers to the first clamp hydraulic line;
wherein the blocking valve is configured for, when in a first position, blocking flow of hydraulic fluid between the first clamp hydraulic line and the one or more opening actuator chambers and configured for, when in a second position, allowing proportionally modulated flow from the one or more opening actuator chambers to the first clamp hydraulic line;
wherein the pilot operated check valve is configured for allowing flow from the second clamp hydraulic line to the one or more closing actuator chambers, but checking flow from the one or more closing actuator chambers to the second clamp hydraulic line unless pressure in the first clamp hydraulic line is sufficient to cause the pilot operated check valve to lift; and
wherein the regeneration valve is configured for, when in a first position, blocking flow of hydraulic fluid between the closing actuator chambers and the opening actuator chambers and configured for, when in a second position, allowing flow of hydraulic fluid between the closing actuator chambers and the opening actuator chambers.

9. A smart clamp load handler comprising:
a first clamp arm and a second clamp arm;
a first actuator coupled to the clamp arms and a second actuator coupled to the second clamp arm, wherein each of the first and second actuators comprise a rod-side actuator, the actuators configured for closing of the clamp arms when hydraulic fluid expands the rod-side actuators, each of the actuators comprising a base-side actuator, the actuators configured for opening of the clamp arms when hydraulic fluid expands the base-side actuators;
a first clamp hydraulic line hydraulically coupled to the base-side actuator;
a second clamp hydraulic line hydraulically coupled to the rod-side actuator;
wherein the first and second clamp hydraulic lines are configured to be coupled to a lift truck;
a base-side control valve hydraulically coupled between the first clamp hydraulic line and the base-side actuators;
one or more base-side pressure sensors, each configured to sense hydraulic pressure applied to one of the base-side actuators; and
a controller configured for controlling an amount of force applied by the clamp arms to a target level by changing positions of the base-side control valve, based on pressure measurements from the one or more base-side pressure sensors.

10. The smart clamp load handler of claim 9, further comprising:
a base-side blocking valve hydraulically coupled in parallel with the base-side control valve;
a rod-side pressure sensor configured to sense hydraulic pressure applied to the rod-side actuators; and
wherein the controller is configured for controlling the amount of force applied by the clamp arms to a target level by changing positions of the base-side control valve and the base-side blocking valve between an unblocked position and a blocked position, based on pressure measurements from the one or more base-side pressure sensors and the rod-side pressure sensor.

11. The smart clamp load handler of claim 10, further comprising:
a regeneration valve hydraulically coupled between the rod-side actuators and the base-side actuators;
an input pressure sensor configured to sense hydraulic pressure applied to the second clamp hydraulic line; and
wherein the controller is configured for controlling the amount of force applied by the clamp arms to a target level by changing positions of the base-side control valve, the base-side blocking valve, and the regeneration valve, based on pressure measurements from the one or more base-side pressure sensors, the rod-side pressure sensor, and the input pressure sensor.

12. The smart clamp load handler of claims 10 and 11, further comprising:
a pilot operated check valve hydraulically coupled between the second clamp hydraulic line and the rod-side actuators with a pilot tube to the first clamp hydraulic line.

13. The smart clamp load handler of claim 11,
a pilot operated check valve hydraulically coupled between the second clamp hydraulic line and the one or more opening actuator chambers with a pilot tube to the first clamp hydraulic line;
wherein the base-side control valve is configured for, when in a first position, allowing flow of hydraulic fluid between the first clamp hydraulic line and the base-side actuators and configured for, when in a second position, allowing flow from the first clamp hydraulic line to the base-side actuators, but checking flow from the base-side actuators to the first clamp hydraulic line;
wherein the base-side blocking valve is configured for, when in a first position, blocking flow of hydraulic fluid between the first clamp hydraulic line and the base-side actuators and configured for, when in a second position, allowing proportionally modulated flow from the base-side actuators to the first clamp hydraulic line;
wherein the regeneration valve is configured for, when in a first position, blocking flow of hydraulic fluid between the rod-side actuators and the base-side actuators and configured for, when in a second position, allowing flow of hydraulic fluid between the rod-side actuators and the base-side actuators; and
wherein the pilot operated check valve is configured for allowing flow from the second clamp hydraulic line to the rod-side actuators, but checking flow from the rod-side actuators to the second clamp hydraulic line unless pressure in the first clamp hydraulic line is sufficient to cause the pilot operated check valve to lift.

14. The smart clamp load handler of claim 10, further comprising:
a flow divider with a combined flow port hydraulically coupled to the base-side control valve and the base-side blocking valve, a first divided flow port hydraulically coupled to a first of the base-side actuators, and a second divided flow port hydraulically coupled to a second of the base-side actuators; and
wherein the one or more base-side pressure sensors includes a first base-side pressure sensor configured to sense hydraulic pressure applied to the first base-side actuator and a second base-side pressure sensor configured to sense hydraulic pressure applied to the second base-side actuator.

15. The smart clamp load handler of claim 14, further comprising:
a first base equalization valve with a first base equalization input port hydraulically coupled to the first base-side actuator and a first base equalization output port coupled to the second base-side actuator; and
a second base equalization valve with a second base equalization input port hydraulically coupled to the second base-side actuator and a second base equalization output port coupled to the first base-side actuator.

16. The smart clamp load handler of claim 11, wherein the controller is further configured for controlling the amount of force applied by the clamp arms to a target level by:
determining a differential pressure between the base-side actuators and the rod-side actuators based on the pressure measurements;
determining the amount of force applied by the clamp arms to a load based on the pressure measurements;
if in a closing phase and contact between the load and the clamp arms has been detected, then entering an equalization phase by putting the base-side control valve in its check valve position and the regeneration valve in its unblocked position;
if in the equalization phase and the differential pressure drops below a first differential pressure threshold, then entering a first force adjustment phase by putting the regeneration valve in its blocked position and the base-side blocking valve in its unblocked position; and
if in the first force adjustment phase and the force applied is determined to have reached a first target force level, then entering a clamped phase by putting the base-side blocking valve in its blocked position.

17. The smart clamp load handler of claim 16, wherein the controller is further configured for controlling the amount of force applied by the clamp arms to a target level by:
if in the clamped phase and the amount of force applied is determined to have exceeded the first target force level by a first target force threshold, then putting the regeneration valve in its unblocked position until the force applied returns to the first target force level; and
if in the clamped phase and the amount of force applied is determined to have dropped below the first target force level by a second target force threshold, putting the base-side blocking valve in its unblocked position until the force applied returns to the first target force level.

18. The smart clamp load handler of claim 17, wherein the controller is further configured for controlling the amount of force applied by the clamp arms to a target level by:
if in the clamped phase and an input pressure measured by the input pressure sensor is less than a rod-side pressure measured by the rod-side pressure sensor and if a base-side pressure measured by the one or more base-side pressure sensors is higher than the rod-side pressure, then entering an open phase by putting the base-side control valve in its unblocked position.

19. The smart clamp load handler of claim 18, wherein the controller is further configured for controlling the amount of force applied by the clamp arms to a target level by:
if in the clamped phase and the amount of force applied is determined to be less than a second target force level and the input pressure drops to less than half of the base-side pressure and the input pressure subsequent rises to more than the base-side pressure, then entering a second force adjustment phase by putting the regeneration valve in its blocked position and the base-side blocking valve in its unblocked position; and
if in the second force adjustment phase and the amount of force applied is determined to have reached the second target force level, then re-entering the clamped phase by putting the base-side blocking valve in its blocked position.

20. The smart clamp load handler of claim 16, wherein the controller is configured for determining when contact between the load and the clamp arms has been detected by:
determining the differential pressure is increasing faster than a second differential pressure threshold.

21. A smart clamp load handler comprising:
a first clamp arm and a second clamp arm;
one or more actuators coupled to the clamp arms, wherein each of the one or more actuators have a rod-side actuator chamber, the one or more actuators configured for closing of the clamp arms when hydraulic fluid expands the one or more rod-side actuator chambers, each of the one or more actuators comprising a base-side actuator chamber, the one or more actuators configured for opening of the clamp arms when hydraulic fluid expands the one or more base-side actuator chambers;
a first clamp hydraulic line hydraulically coupled to the one or more base-side actuator chambers;
a second clamp hydraulic line hydraulically coupled to the one or more rod-side actuator chambers;
wherein the first and second clamp hydraulic lines are configured to be coupled to a lift truck;
a base-side control valve hydraulically coupled between the first clamp hydraulic line and the one or more base-side actuator chambers;
a base-side blocking valve hydraulically coupled between the first clamp hydraulic line and the one or more base-side actuator chambers;
a regeneration valve hydraulically coupled between the one or more rod-side actuator chambers and the one or more base-side actuator chambers;
a pilot operated check valve hydraulically coupled between the second clamp hydraulic line and the one or more rod-side actuator chambers with a pilot tube to the first clamp hydraulic line;
a differential pressure sensor configured to sense hydraulic pressure between the one or more base-side actuator chambers and the one or more rod-side actuator chambers; and
a controller configured for controlling force applied by the clamp arms by changing positions of the base-side control valve, the base-side blocking valve, and the regeneration valve, based on pressure measurements from the differential pressure sensor.

22. The smart clamp load handler of claim 21,
wherein the base-side control valve is configured for, when in a first position, allowing flow of hydraulic fluid between the first clamp hydraulic line and the one or more base-side actuator chambers and configured for, when in a second position, allowing flow from the first clamp hydraulic line to the one or more base-side actuator chambers, but checking flow from the one or more base-side actuator chambers to the first clamp hydraulic line;
wherein the base-side blocking valve is configured for, when in a first position, blocking flow of hydraulic fluid between the first clamp hydraulic line and the one or more base-side actuator chambers and configured for, when in a second position, allowing proportionally modulated flow from the one or more base-side actuator chambers to the first clamp hydraulic line;
wherein the regeneration valve is configured for, when in a first position, blocking flow of hydraulic fluid between the one or more rod-side actuator chambers and the one or more base-side actuator chambers and configured for, when in a second position, allowing flow of hydraulic fluid between the one or more rod-side actuator chambers and the one or more base-side actuator chambers; and
wherein the pilot operated check valve is configured for allowing flow from the second clamp hydraulic line to the one or more rod-side actuator chambers, but checking flow from the one or more rod-side actuator chambers to the second clamp hydraulic line unless pressure in the first clamp hydraulic line is sufficient to cause the pilot operated check valve to lift.

23. A smart clamp load handler comprising:
a first clamp arm and a second clamp arm;
one or more actuators coupled to the clamp arms, wherein each of the one or more actuators have a rod-side actuator chamber, the one or more actuators configured for closing of the clamp arms when hydraulic fluid expands the one or more rod-side actuator chambers, each of the one or more actuators comprising a base-side actuator chamber, the one or more actuators configured for opening of the clamp arms when hydraulic fluid expands the one or more base-side actuator chambers;
a first clamp hydraulic line hydraulically coupled to the one or more base-side actuator chambers;
a second clamp hydraulic line hydraulically coupled to the one or more rod-side actuator chambers;
wherein the first and second clamp hydraulic lines are configured to be coupled to a lift truck;
a regeneration valve hydraulically coupled between the one or more rod-side actuator chambers and the one or more base-side actuator chambers;
a pilot operated check valve hydraulically coupled between the second clamp hydraulic line and the one or more rod-side actuator chambers with a pilot tube to the first clamp hydraulic line;
one or more base-side pressure sensors, each configured to sense hydraulic pressure applied to one of the base-side actuator chambers;
a rod-side pressure sensor configured to sense hydraulic pressure applied to the one or more rod-side actuator chambers;
an input pressure sensor configured to sense hydraulic pressure applied to the second clamp hydraulic line; and
a controller configured for controlling force applied by the clamp arms by changing positions of the regeneration valve, based on pressure measurements from the one or more base-side pressure sensors, the rod-side pressure sensor, and the input pressure sensor.

24. The smart clamp load handler of claim 23,
wherein the regeneration valve is configured for, when in a first position, blocking flow of hydraulic fluid between the one or more rod-side actuator chambers and the one or more base-side actuator chambers and configured for, when in a second position, allowing flow of hydraulic fluid between the one or more rod-side actuator chambers and the one or more base-side actuator chambers; and
wherein the pilot operated check valve is configured for allowing flow from the second clamp hydraulic line to the one or more rod-side actuator chambers, but checking flow from the one or more rod-side actuator chambers to the second clamp hydraulic line unless pressure in the first clamp hydraulic line is sufficient to cause the pilot operated check valve to lift.

25. A smart clamp load handler comprising:
a first clamp arm and a second clamp arm;
one or more actuators coupled to the clamp arms, wherein each of the one or more actuators have a rod-side actuator chamber, the one or more actuators configured for closing of the clamp arms when hydraulic fluid expands the one or more rod-side actuator chambers, each of the one or more actuators comprising a base-side actuator chamber, the one or more actuators configured for opening of the clamp arms when hydraulic fluid expands the one or more base-side actuator chambers;
a first clamp hydraulic line hydraulically coupled to the one or more base-side actuator chambers;
a second clamp hydraulic line hydraulically coupled to the one or more rod-side actuator chambers;
wherein the first and second clamp hydraulic lines are configured to be coupled to a lift truck;
a pilot operated check valve hydraulically coupled between the second clamp hydraulic line and the one or more rod-side actuator chambers with a pilot tube to the first clamp hydraulic line;
a rod-side control valve hydraulically coupled between the second clamp hydraulic line and the pilot operated check valve;
a rod-side blocking valve hydraulically coupled between the second clamp hydraulic line and the pilot operated check valve;
one or more base-side pressure sensors, each configured to sense hydraulic pressure applied to one of the base-side actuator chambers;
a rod-side pressure sensor configured to sense hydraulic pressure applied to the one or more rod-side actuator chambers; and
a controller configured for controlling force applied by the clamp arms by changing positions of the rod-side control valve and the rod-side blocking valve, based on pressure measurements from the one or more base-side pressure sensors and the rod-side pressure sensor.

26. The smart clamp load handler of claim 25,
wherein the rod-side control valve is configured for, when in a first position, allowing flow of hydraulic fluid between the second clamp hydraulic line and the one or more rod-side actuator chambers and configured for, when in a second position, allowing flow from the second clamp hydraulic line to the one or more rod-side actuator chambers, but checking flow from the one or more rod-side actuator chambers to the second clamp hydraulic line;
wherein the rod-side blocking valve is configured for, when in a first position, blocking flow of hydraulic fluid between the second clamp hydraulic line and the one or more rod-side actuator chambers and configured for, when in a second position, allowing proportionally modulated flow from the one or more rod-side actuator chambers to the second clamp hydraulic line; and
wherein the pilot operated check valve is configured for allowing to the one or more rod-side actuator chambers, but checking flow from the one or more rod-side actuator chambers unless pressure in the first clamp hydraulic line is sufficient to cause the pilot operated check valve to lift.

27. A method for a controller of an accessory for a lift truck, the accessory having a plurality of components including one or more actuators, one or more valves, and one or more hydraulic lines, the method comprising the steps of:
receiving one or more measurements of one or more properties of one or more of the plurality of components, including hydraulic pressure applied to an opening chamber of one of the one or more actuators and includes hydraulic pressure applied to a closing chamber of one of the one or more actuators;
change a current state of the accessory from a first state to a second state based on the one or more measurements and the current state; and
controlling the one or more actuators by changing positions of the one or more valves based on the one or more measurements and the current state.

28. The method of claim 27, further comprising the steps of:
determining if a first property of the one or more properties has reached a first target level and if so then sending to a control console an indication that the first property has reached the first target level.

29. The method of claim 28, further comprising the steps of:
determining if the first property of the one or more properties has reached a second target level and if so then sending to the control console an indication that the first property has reached the second target level.

30. The method of claim 29, further comprising the steps of:
wherein the one or more properties of one or more of the plurality of components includes a differential hydraulic pressure between the opening and closing chambers of the one or more actuators;
wherein the first property is a force applied by the one or more actuators;
wherein the force applied is determined based on the differential hydraulic pressure;
wherein the first target level is a first target force level;
wherein the second target level is a second target force level; and
wherein the first state is a slow adjustment phase and the second state is a clamped phase.

31. A controller for an accessory for a lift truck, the accessory having a plurality of components including one or more actuators, one or more valves, and one or more hydraulic lines, the controller having logic to:
receiving one or more measurements of one or more properties of one or more of the plurality of components, including hydraulic pressure applied to an opening chamber of one of the one or more actuators and includes hydraulic pressure applied to a closing chamber of one of the one or more actuators;
change a current state of the accessory from a first state to a second state based on the one or more measurements and the current state; and
controlling the one or more actuators by changing positions of the one or more valves based on the one or more measurements and the current state.

32. The controller of claim 31, further having logic to:
determining if a first property of the one or more properties has reached a first target level and if so then sending to a control console an indication that the first property has reached the first target level.

33. The controller of claim 32, further having logic to:
determining if the first property of the one or more properties has reached a second target level and if so then sending to the control console an indication that the first property has reached the second target level.

34. The controller of claim 33, further having logic to:
wherein the one or more properties of one or more of the plurality of components includes a differential hydraulic pressure between the opening and closing chambers of the one or more actuators;
wherein the first property is a force applied by the one or more actuators;
wherein the force applied is determined based on the differential hydraulic pressure;
wherein the first target level is a first target force level;
wherein the second target level is a second target force level; and
wherein the first state is a slow adjustment phase and the second state is a clamped phase.

35. A non-transient computer readable medium with instructions coded thereon that when executed by a processor executes steps for control of an accessory for a lift truck, the accessory having a plurality of components including one or more actuators, one or more valves, and one or more hydraulic lines, the steps comprising:
receiving one or more measurements of one or more properties of one or more of the plurality of components, including hydraulic pressure applied to an opening chamber of one of the one or more actuators and includes hydraulic pressure applied to a closing chamber of one of the one or more actuators;
change a current state of the accessory from a first state to a second state based on the one or more measurements and the current state; and
controlling the one or more actuators by changing positions of the one or more valves based on the one or more measurements and the current state.

36. The non-transient computer readable medium of claim 35, further coded with instructions comprising the steps of:
determining if a first property of the one or more properties has reached a first target level and if so then sending to a control console an indication that the first property has reached the first target level.

37. The non-transient computer readable medium of claim 36, further coded with instructions comprising the steps of:
determining if the first property of the one or more properties has reached a second target level and if so then sending to the control console an indication that the first property has reached the second target level.

38. The method of claim 37, further comprising the steps of:
wherein the one or more properties of one or more of the plurality of components includes a differential hydraulic pressure between the opening and closing chambers of the one or more actuators;
wherein the first property is a force applied by the one or more actuators;
wherein the force applied is determined based on the differential hydraulic pressure;
wherein the first target level is a first target force level;
wherein the second target level is a second target force level; and
wherein the first state is a slow adjustment phase and the second state is a clamped phase.

39. A smart clamp load handler comprising:
a first clamp arm and a second clamp arm;
one or more actuators coupled to the clamp arms, wherein each of the one or more actuators have an opening actuator chamber and a closing chamber;
a control valve with a first port and a second port, the first port hydraulically coupled to the opening actuator chambers;
a first pressure sensor configured to sense hydraulic pressure applied to at least one of the one or more opening actuator chambers; and
a controller configured for controlling an amount of force applied by the clamp arms to a target level by changing positions of the control valve, based on pressure measurements from the first pressure sensor.

40. The smart clamp load handler of claim 39, further comprising:
a blocking valve hydraulically coupled in parallel with the control valve;
a second pressure sensor configured to sense hydraulic pressure applied to the one or more closing actuator chambers; and
wherein the controller is configured for controlling the amount of force applied by the clamp arms to a target level by changing positions of the control valve and the blocking valve, based on pressure measurements from the first pressure sensor and the second pressure sensor.

41. The smart clamp load handler of claim 40, further comprising:
a pilot operated check valve hydraulically coupled between the closing actuator chambers of the one or more actuators and the one or more opening actuator chambers with a pilot line hydraulically coupled to the second port of the control valve.

42. The smart clamp load handler of claim 39, further comprising:
a second pressure sensor configured to sense hydraulic pressure applied to at least one of the one or more closing actuator chambers; and
wherein the controller is configured for controlling the amount of force applied by the clamp arms to a target level by:
determining a differential pressure between the one or more opening actuator chambers and the one or more closing actuator chambers based on pressure measurements from the first pressure sensor and the second pressure sensor; and
putting the control valve in a position that blocks flow through the control valve from the opening chambers if a rate of change of the differential pressure is greater than a differential pressure rate of change threshold.

43. A smart clamp load handler comprising:
a first clamp arm and a second clamp arm;
one or more actuators coupled to the clamp arms, wherein each of the one or more actuators have an opening chamber and a closing chamber;
a control valve with a first port and a second port, the first port hydraulically coupled to the one or more closing chambers;
a first pressure sensor configured to sense hydraulic pressure applied to the one or more closing chambers; and
a controller configured for controlling an amount of force applied by the clamp arms to a target level by changing positions of the control valve based on pressure measurements from the first pressure sensor.

44. The smart clamp load handler of claim 43, further comprising:
wherein the controller is configured for controlling the amount of force applied by the clamp arms to a target level by:
putting the control valve in a position that blocks flow through the control valve to the one or more closing chambers if pressure measured by the first pressure sensor is greater a first pressure threshold.

45. The smart clamp load handler of claim 43 or 44, further comprising:
a blocking valve hydraulically coupled in parallel with the control valve; and
wherein the controller is configured for controlling the amount of force applied by the clamp arms to a target level by changing positions of the control valve and the blocking valve based on pressure measurements from the first pressure sensor.

46. The smart clamp load handler of claim 45, further comprising:
a pilot operated check valve hydraulically coupled between the closing chambers and the first port of the control valve with a pilot line hydraulically coupled to the opening chambers.
